(19) United States
(12) Patent Application Publication
(10) Pub. No.: US 2006/0024539 A1
(43) Pub. Date: Feb. 2, 2006

(54) Catalytic method to remove CO and utilize its energy content in CO-containing streams

(76) Inventors: James A. Dumesic, Verona, WI (US); Won Bae Kim, Madison, WI (US)

Correspondence Address: Joseph T. Leone;DeWitt Ross & Stevens S.C., 8000 Excelsior Drive, Madison, WI, 53717, US

(21) Appl. No.: 10/901,761

(22) Filed: Jul. 29, 2004

(51) Int. Cl. H01M 8/06; C01B 31/20

(52) U.S. Cl. 429/17; 423/437.2; 429/19

(57) ABSTRACT

Disclosed are a reactor and a corresponding method for producing electrical energy using a fuel cell by selectively oxidizing CO at room temperature using polyoxometalate compounds and transition metal compounds over metal-containing catalysts, thereby eliminating the water-gas shift reaction and the need to transport and vaporize liquid water in the production of H₂ for fuel cells. The reactor also functions to deplete CO from an incoming gas stream.

### INCORPORATION BY REFERENCE

All of the documents cited below are incorporated herein by reference.

### BACKGROUND

The production of H₂ for fuel cells typically involves forming a mixture of H₂, CO and CO₂ from hydrocarbons or oxygenated hydrocarbons (1-5), followed by the water-gas shift (WGS) reaction (CO+H₂O→CO₂+H₂) and preferential oxidation (PROX) of CO in H₂-rich gas streams. This yields a high conversion of CO to CO₂ (6-9), which is required in conventional proton exchange membrane (PEM) fuel cells because of the strong poisoning effect of CO on Pt-based anodes (10). The WGS reaction therefore represents a major bottleneck in the production of H₂ because the reaction is exothermic and slow at the low temperatures (−500 K) required to yield favorable equilibrium conversions. Moreover, because large amounts of water are vaporized in the WGS reaction, implementing the WGS reaction in portable applications is not feasible; vast quantities of water would have to be transported. As described herein, the present invention eliminates the need for the WGS reaction by coupling the oxidation of CO to CO₂ to the reduction of a polyoxometalate (POM) species present in aqueous solution. The invention has two immediately apparent benefits: (1) eliminating CO from the gas stream (thereby yielding a purified H₂ stream suitable for use in a proton exchange membrane (PEM) fuel cell; and (2) yielding a solution of reduced POM which itself can be oxidized as fuel at the anode of a PEM fuel cell to generate power.

POMs belong to a large class of nanosized metal-oxygen cluster anions. POMs form by a self-assembly process, typically in an acidic aqueous solution and can be isolated as solids with an appropriate counter-cation, for example, H⁺, alkali metals, NH₄⁺, and the like.

In the chemical literature, two types of POMs are distinguished based on their chemical composition: isopoly anions and heteropoly anions. These anions may be represented by the general formulae:

| | |
|---|---|
| [MₘO_{y}]^{p-} | Isopoly anions |
| [Xₓ MₘO_{y}]^{q-} (x ≦ m) | Heteropoly anions |

The “M” moiety is called the addenda atom and the “X” moiety the heteroatom (also called the central atom when located in the center of the polyanion). The distinction between the two groups is frequently artificial, especially in the case of mixed addenda POMs. Thus, as used herein, the term “POM” explicitly refers to both isopoly anions and heteropoly anions.

POMs that are heteropoly acids (strong acids composed of heteropoly anions, with protons as the countercations) constitute a special sub-class of POMs that is particularly important for various catalytic applications in the prior art.

The most common addenda atoms (“M”) are molybdenum or tungsten, less frequently vanadium or niobium, or mixtures of these elements in their highest oxidation states (d⁰, d¹). A far broader range of elements can act as the heteroatoms. In fact, essentially all elements of the Periodic Table can be incorporated as the heteroatom in a POM. The most typical for the catalytic POMs described in the prior art are P⁵⁺, As⁵⁺, Si⁴⁺, Ge⁴⁺, B³⁺, etc. Molybdenum (VI) and tungsten (VI) most readily form POMs due to their favorable combination of ionic radius, charge, and the accessibility of empty d orbitals for metal-oxygen bonding.

A systematic nomenclature of POMs has been developed. It uses a labeling system for the metal atoms and, in some cases, for the oxygen atoms to avoid ambiguity. The resulting names, however, are very long and cumbersome; hence the systematic nomenclature is rarely used for routine purposes. In prior art catalytic uses, only a relatively small number of well-known types of POMs are used. These are largely limited to the Keggin structure compounds and their derivatives. Usually, therefore, a simplified conventional nomenclature, sometimes even trivial names, are sufficient for reporting and retrieving information in the field. The current simplified nomenclature treats POMs (also referred to as heteropoly anions, polyoxoanions, or polyanions) as quasi-coordination complexes. The heteroatom, if present, is considered as the central atom of a complex, and the addenda moieties as the ligands. In the formulae of heteropoly anions, the heteroatoms are placed before the addenda, and the countercations before the heteroatoms; the heteropoly anion is placed in square brackets and thus separated from the countercations, as illustrated by the following examples:

| | |
|---|---|
| [SiW₁₂O₄₀]⁴⁻ | 12-tungstosilicate or dodecatungstosilicate |
| H₃[PMo₁₂O₄₀] | 12-molybdophosphoric acid |
| Na₅[PMo₁₀V₂O₄₀] | sodium decamolybdodivanadophosphate |

For simplicity, the countercations and the charge of polyanion and even the oxygen atoms are sometimes omitted; for example, Na₆[P₂ Mo₁₈O₆₂] may be abbreviated to [P₂Mo₁₈O₆₂] or simply P₂Mo₁₈.

The history of POMs dates back to 1826 when Berzelius discovered the first heteropoly salt, ammonium 12-molybdophosphate. In 1848, Svanberg and Struve introduced this compound to analytical chemistry as the basis for a widely used method to determine the presence of phosphorous. By the early 1900's, approximately 750 POMs had been reported in the literature. The structure of POMs was not elucidated until 1933, when Keggin solved the structure of the most important 12:1-type POM by a powder X-ray diffraction study of H₃[PWI20₄₀].5H₂O. Keggin (1934) Proc. Roy. Soc. London, A144:75. This structure, now named after is discovered, contains 12 WO₆ octahedra linked by edge and corner sharing, with the heteroatom occupying a tetrahedral hole in the center.

The synthesis, characterization, reactivity, and catalytic activity of POMs have been reviewed extensively. Seminal monographs include, for example, Souchay, Ions Mineraux Condenses, Masson, Paris, 1969; and Pope (1983) Heteropoly and Isopoly Oxometalates, Springer, Berlin. For reviews, see Day & Klemperer (1985) Science 228:533; Pope & Muller (1991) Angew. Chem. Int. Ed. Engl 30:34; Jeannin, Herve, and Proust (1992) Inorg. Chim Acta 198-200:319; and Chen & Zubieta (1992) Coord. Chem Rev. 114:107. A vast amount of useful information about the chemistry and various applications of POMs, including the nomenclature, synthesis of organic and organometallic derivatives of POMs, electron-transfer reactions, very large POMs clusters, solutions equilibria, POMs-based molecular materials, scanning probe microscopy of POM surfaces, photo- and electrochromism, and the application of POMs in medicine, can be found in recent collections. See, for example, Polyoxymetalate Molecular Science, Juan J. Borras-Almeuar, ©2004 Kluwer Academic Publishers, NY; Polyoxymetalate Chemistry for Nano-Composite Design, Toshiho Yamase, Michael T. Pope, Eds. ©2004 Kluwer Academic Publishers, NY; and Catalysts for Fine Chemical Synthesis, VoL 2: Catalysis by Polyoxymetalates, Ivan Kozhevnikov, ©2002, Wiley, NY.

The prior art, however, is completely silent with regard to using an aqueous solution of a POM to remove CO from an incoming gas stream (by oxidizing the CO to CO₂) and then using the reduced form of the POM in aqueous solution as a fuel for generating electricity in a fuel cell.

### SUMMARY OF THE INVENTION

Producing hydrogen for fuel cells typically involves forming a mixture of H₂, CO and CO₂ from hydrocarbons or oxygenated hydrocarbons by such processes as steam reforming, aqueous-phase reforming, partial oxidation, or pyrolysis. The resulting synthesis gas is then subjected to the water-gas shift (WGS) reaction (CO+H₂O→CO₂+H₂) (conducted at moderate temperatures, typically 573 K), to convert CO to CO₂. The WGS reaction is required in conventional hydrogen production methods to decrease the concentration of CO in the hydrogen fuel destined for proton exchange membrane (PEM) fuel cells. As noted earlier, the dual requirements of: (1) operating at low temperatures; and (2) converting most of the CO to CO₂, causes the WGS reaction to be a major bottleneck in the production of H₂ for fuel cells.

In the present invention, a new process that bypasses the conventional WGS reaction in the production of H₂ for fuel cells is disclosed. This process, utilizing noble metal catalysts (preferably gold) not only removes CO from gas streams, but it utilizes the CO to produce an aqueous solution of reduced POM compound(s) that can be used to power a PEM fuel cell. Moreover, the anode in a fuel cell operating with this energy-storage solution can be fashioned from carbon, thereby decreasing the cost of fuel cells by minimizing (or even eliminating) the use of platinum or its alloys.

The preferred process for oxidizing and using CO involves reacting CO and liquid water with reducible polyoxometalate compounds (preferably H₃PMo₁₂O₄₀) over gold nanotubes or nanoparticles. The reaction takes advantage of the high catalytic activities of gold nanoparticles for CO oxidation (11-13), especially in the presence of liquid water (14,15). This catalytic process can be accomplished at room temperature (e.g., preferably about 298 K, but generally about 300 K or less). In sharp contrast, existing methods to produce hydrogen from CO and H₂O (i.e., the WGS reaction) must be operated at elevated temperatures (at least 400 K and typically above 500 K) (6,16). In the present invention, carbon monoxide is removed from the gas stream by oxidizing it to CO₂, while simultaneously reducing an aqueous solution of polyoxometalate species. The reduced polyoxometalate solution formed thus contains stored energy in the form of protons and electrons associated with the reduced metal cations. In short, the present invention for CO oxidation not only removes CO from gas streams destined to be used in fuel cells, but the process also converts the energy content of CO into a liquid (the reduced polyoxometalate solution) that can subsequently be used to power a fuel cell.

A critical distinction in the present invention is that in the preferred embodiment it uses reversible oxidation-reduction reagents. (Note that the inventive method is not required to use a reversible redox reagent, but it is vastly preferred.) Thus, whereas previous studies of CO oxidation have used irreversible oxidizing agents such as O₂ (17,18), the present invention uses aqueous-phase POM compounds that undergo reversible oxidation-reduction reactions. In this way, the reducible POM compound facilitates the CO removal step and then serves as a fuel for the electrical energy generation step, eliminating the need to produce H₂ as a reaction intermediate for power generation.

One of the major challenges in implementing wide spread use of hydrogen fuel cells is the safe storage of fuels that have high energy densities and yet can be efficiently converted to a form that is utilized efficiently by a fuel cell. For example, extensive research is being conducted to search for new solid adsorbents that allow high densities of H₂ to be stored and desorbed reversibly at low temperatures and pressures. Alternatively, sufficient energy can be stored in liquid fuels that can then be converted to a reformate gas (e.g., H₂, CO, CO₂, H₂O) that is processed further (e.g., by the WGS reaction or by preferential oxidation of CO). The purified H₂ is then sent to a fuel cell to generate electrical power.

One embodiment of the invention, however, is a two-step process for producing energy from CO. The invention reveals an entirely new paradigm for producing energy economically from fuels having high energy densities. In particular, an aqueous solution containing a reducible POM compound is used as an energy-transfer medium. Energy is stored temporarily (and at high density) in the reduced form of the POM compound. The energy is released as needed when the solution is oxidized at a fuel cell anode. The preferred energy storage solution is a non-flammable liquid that is stable in air. The preferred solution has an energy density typically of about 5 moles of electrons per liter, which corresponding to 70 Wh per liter of energy for a fuel cell operating at 0.5 V.

Moreover, because storing the energy into the aqueous solution and releasing the energy at the fuel cell are conducted under different conditions, the fuel cell electrodes need not contain precious metals. This is a distinct benefit of the present invention because eliminating the need for precious metals in the fabrication of fuel cells significantly lowers their cost.

Using the fuel cell disclosed herein, electricity was produced by catalytic oxidation of carbon monoxide (CO) utilizing noble metal catalysts at room temperature (i.e., about 23° C.). The observed rates are faster than conventional processes operating at 500 K or higher for conversion of CO with water to produce hydrogen and carbon dioxide (via the WGS reaction). By eliminating the WGS reaction, the need to transport and vaporize liquid water to produce energy for portable applications is rendered unnecessary. The inventive method disclosed herein functions to produce electricity using CO-containing gas streams from catalytic reforming of hydrocarbons to produce an aqueous solution of reduced POM compounds that can be used to generate power. The reduced POM can be re-oxidized in fuel cells containing simple carbon anodes.

Thus, a first embodiment of the invention is directed to a method to produce energy from carbon monoxide. The method comprises reacting a gas comprising carbon monoxide with a solution comprising an oxidized polyoxometalate (POM) in the presence of a metal-containing catalyst. This is done under conditions and for a time sufficient to reduce the POM to a reduced POM and to oxidize the carbon monoxide to carbon dioxide. The reduced POM is then oxidized in a fuel cell to generate energy.

The preferred POMs for use in the invention are those of formula I or II:
[Y₃₋₁₈]ⁿ⁺[X₁₋₄M₁₋₃₆O₁₀₋₆₀]ⁿ⁻ (I)
[Y₃₋₁₈]ⁿ⁺[M₁₋₃₆O₁₀₋₆₀]ⁿ⁻ (II)
wherein each “X” is independently selected from the group consisting of any element or molecular moiety having four or less atoms, each “M” is independently selected from the group consisting of metals, “Y” is a counter-cation, and “n” is an integer, acid forms thereof, salt forms thereof, and partial-salt forms thereof. More preferably still, each “X” is independently selected from the group consisting of P, Si, As, Ge, B, Co, S, and Fe; each “M,” is independently selected from the group consisting of Mo, W, V, Ti, Co, Cu, Zn, Fe, Ni, Cr, lanthanides, Ce, Al, Ga, In, and Tl; each “Y” is a counter-cation selected from the group consisting of H, Zn, Co, Cu, Bi, Na, Li, K, Rb, Cs, Ba, Mg, Sr, ammonium, C₁₋₂-alkylammonium, and C₁₋₁₂-alkylamine; and “n” is an integer, acid forms thereof, salt forms thereof, and partial-salt forms thereof.

Preferred POMs for use in the present invention also include POMs of formula III:
[Y_{y}]ⁿ⁺[XM12O₄₀]ⁿ⁻ (III)
wherein “X:” is selected from the group consisting of Si, P, and Ge; each “M,” is independently selected from the group consisting of Mo, W, and V; each “Y” is a counter-cation independently selected from the group consisting of H, Zn, Co, Cu, Bi, Na, Li, K, Rb, Cs, Ba, Mg, Sr, ammonium, C₁₋₁₂-alkylammonium, and C₁₋₁₂-alkylamine, and combinations thereof, and “n” and “y” are integers, acid forms thereof, salt forms thereof, and partial-salt forms thereof.

As used herein, when a variable moiety, such as “M,” in any of formulae I, II, or III is defined as being “independently selected” from a group of recited elements, if there are a plurality of such moieties present, the various moieties can be different from one another within the same compound. Thus, for example, the designation “MI₂” in formula III, explicitly encompasses, for example, compounds wherein each “M,” is identical, as in Mo₁₂, and compounds wherein the various “M” moieties are different, as in Mo₁₀V₂.

A second embodiment of the invention is directed to a method to produce energy from carbon monoxide. Here, the method comprises reacting a gas comprising carbon monoxide with a solution comprising an oxidized polyoxometalate (POM) in the presence of a metal-containing catalyst, wherein the metal-containing catalyst is selected from the group consisting of Group VIIIB metal-containing catalysts and Group IB metal-containing catalysts, under conditions and for a time sufficient to reduce the POM to a reduced POM and to oxidize the carbon monoxide to carbon dioxide. The reduced POM is then oxidized in a fuel cell to generate energy. The POMs that can be used in this embodiment of the invention are the same as described for the first embodiment.

A third embodiment of the invention is directed to a method to deplete carbon monoxide from a stream of gas. The method comprises reacting an incoming gas comprising carbon monoxide with a solution comprising an oxidized polyoxometalate (POM) and/or a transition metal, in the presence of a metal-containing catalyst, under conditions and for a time sufficient to reduce the POM and to oxidize the carbon monoxide to carbon dioxide, thereby depleting carbon monoxide from the stream of gas. The POMs that can be used in this embodiment of the invention are the same as described for the first embodiment.

A fourth embodiment of the invention is a reactor to remove carbon monoxide from a stream of gas. The reactor comprises a first reaction chamber having an inlet and an outlet, wherein the inlet is dimensioned and configured to introduce a reactant gas comprising carbon monoxide into the first reaction chamber, and the outlet is dimensioned and configured to vent a product gas depleted of carbon monoxide from the first reaction chamber. The invention further includes a second reaction chamber having an inlet and an outlet, wherein the inlet is dimensioned and configured to introduce an oxidized condensed liquid reactant into the second reaction chamber, and the outlet is dimensioned and configured to vent a reduced condensed liquid product from the second reaction chamber. A membrane is disposed between the first reaction chamber and the second reaction chamber. The gas- and liquid-permeable membrane is in contact with both the first and second reaction chambers and separates the first reaction chamber from the second reaction chamber. A metal-containing catalyst is disposed on the membrane, and the metal-containing catalyst is dimensioned and configured to catalyze a coupled oxidation-reduction reaction wherein within the first reaction chamber carbon monoxide present in the reactant gas is selectively oxidized to yield the product gas depleted of carbon monoxide, and within the second reaction chamber the oxidized condensed liquid reactant is reduced to yield the reduced condensed liquid product.

A fifth embodiment of the invention is directed to a device to generate electricity. The device comprises a reactor as disclosed in the immediately preceding paragraph and a fuel cell operationally connected to the reactor. The device further includes conduit operationally connecting the outlet of the second reaction chamber to the anode chamber of the fuel cell, wherein the conduit is dimensioned and configured to transfer the reduced condensed liquid product from the second reaction chamber of the reactor to the anode chamber of the fuel cell.

### BRIEF DESCRIPTION OF THE FIGURES

FIGS. 1A, 1B, and 1C. Schematic diagrams of a membrane reactor according to the present invention (FIG. 1A) coupled to two different types of fuel cells according to the present invention (FIGS. 1B and 1C) to study CO oxidation at the membrane reactor of FIG. 1A and energy transfer at the fuel cells of FIGS. 1B and 1C.

FIG. 2. Rate of CO oxidation with POM (H₃PMo₁₂O₄₀) on gold nanotube membranes at 298 K and a total pressure of 1 bar. Rate of CO₂ production on membrane prepared by electroless deposition of gold for 2 hours versus POM concentration (filled circles, -●-), versus CO partial pressures (M=0.01) (empty triangles, -Δ-), and the corresponding values after RIE treatment to remove 1 and 2 μm of membrane (empty circles, -◯-). Rates also shown on membrane prepared by electroless deposition of gold for 0.25 h versus POM concentration (filled squares, -▪-).

FIG. 3. Voltage-current curves on the various combinations of anodes, membranes, and cathodes with reduced H₃PMo₁₂O₄₀ solution used as fuel. As an oxidant, O₂ was used for the Pt cathode and oxidized H₃PMo₁₂O₄₀ was used for gold or carbon cathodes. All curves were obtained using 0.5 M H₃PMo₁₂O₄₀, except the filled squares and circles with 1 M solution. AuNT=gold nanotube membrane deposited for 2 h with surface gold; Pt=Pt/C cathode; GC=graphitic carbon; CP=carbon paper. Legend: (-◯-)=AuNT/Nafion® PEM/Pt; (-□-)=AuNT/Nafion® PEM/AuNT; (-Δ-)=GC on CP/Nafions PEM/Pt; (-▴-)=GC on CPINafion® PEMIPt (hot-pressed); (-▪-)=1 M GC on CP/Nafion® PEM/Pt; (-●-)=1 M GC on CP/Nafion® PEM/GC on CP.

FIGS. 4A, 4B, 4C. Field-emission scanning electron microscopy images of gold nanotubes used as membrane catalysts for CO oxidation and electrodes for the preferred fuel cell with a scale bar of 200 nm. FIG. 4A: Gold nanotubes formed by electroless deposition for 2 h after RIE. FIG. 4B: Gold nanotubes formed by electroless deposition for 0.25 h without surface gold. FIG. 4C: Gold nanotubes formed by electroless deposition for 2 h with surface gold.

FIG. 5. Rate of CO oxidation with phosphomolybdovanadate POMs (PVMo₁₂₋ₙO₄₀ anions) on Au/C catalyst (World Gold Council, 4D). Legend: (-●-)=specific rate of CO₂ production for Na_{n'}[PVₙMo₁₂₋ₙO₄₀]; (-◯-)=TOF for Naₙ₊₃[PVₙMo₁₂₋ₙO₄₀]; (-▪-)=specific rate for Hₙ₊₃[PVₙMo₁₂₋ₙO₄₀]; (-▴-)=specific rates for HNa₆[PV₄Mo₈O₄₀] and H₃Na₄[PV₄Mo₈O_{40].}

FIG. 6. Voltage-current curves on solutions of reduced POMs (Hₙ₊₃[PVₙMo₁₂₋ₙO₄₀] with n=0, 2, or 4) as fuel to carbon anode. As an oxidant, O₂ was used for the Pt cathode and oxidized POMs were employed for carbon cathode. Legend: (-▴-)=reduced 0.2 M H₇[PV₄Mo₈O₄₀] at anode and O₂ at cathode; (-Δ-)=reduced H₃PMo₁₂O₄₀ at anode and oxidized 0.2 M H₇[PV₄Mo₈O₄₀] at cathode; (-▪-)=reduced 0.2 M H₅[PV₂Mo₁₀O₄₀] at anode and O₂ at cathode; (-□-)=reduced H₃PMo₁₂O₄₀ at anode and oxidized 0.2 M H₅[PV₂Mo₁₀O₄₀] at cathode.

### DETAILED DESCRIPTION OF THE INVENTION

Abbreviations and Definitions:

The following abbreviations and definitions are used throughout the specification and claims. Words not explicitly defined herein are to be according their accepted definition in the field of fuel cell technology.

“AuNT”=gold nanotube membrane.

“CP”=carbon paper.

“GC”=graphitic carbon.

“PEM”=proton exchange membrane.

“Polyoxometalate”=Any polyoxometalate anion (isopoly anions and heteropoly anions), acids thereof, and salts thereof, fabricated by any means.

“Noble metals”=Cu, Ag, Au, Pt, Pd, Ir, Ru, and Rh.

“POM”=polyoxometalate.

“PROX”=preferential oxidation.

“RIE”=reactive ion etching “Room temperature”=30° C. or less; preferably 25° C. or less.

“WGC”=World Gold Council, 45 Pall Mall, London SW1Y 5JG, United Kingdom.

“WGS”=water-gas shift.

Polyoxometalates (POMs) for Use in the Present Invention:

Any POM (isopoly anions and heteropoly anions), acid forms thereof, and/or salt forms and partial salt forms thereof, fabricated by any means, can be used in the present invention. It is much preferred that the POM chosen reversibly undergoes oxidation-reduction reactions in aqueous solution, although this is not strictly required. This includes (without limitation) Keggin structure POMs and Wells/Dawson structure POMs. As used herein, the term “POM” is explicitly defined to encompass compounds that are alternatively referred to in the relevant chemical literature as heteropoly acids, heteropoly compounds, heteropoly anions, heteropolyoxo anions, or polyoxometallates. The preferred class of POMs are compounds having the formula [Y₃₋₁₈]ⁿ⁺[X₁₋₄M₁₋₃₆O₁₀₋₆₀]ⁿ⁻ where “X” is independently selected from any element or molecular moiety having four or less atoms, “M” is independently selected from metals, “Y” is a counter-cation, and “n” is an integer, acid forms thereof, salt forms thereof, and partial-salt forms. Also preferred are polyoxymetalates of the formula [Y₃₋₁₈]ⁿ⁺[M₁₋₃₆O₁₀₋₆₀]ⁿ⁻, where “Y,” “M,” and “n” are as defined previously.

In the preferred embodiments, each “X” moiety is preferably independently selected from the group consisting of P, Si, As, Ge, B, Co, S, Fe. Each “M” moiety is preferably independently selected from the group consisting of Mo, W, V, Ti, Co, Cu, Zn, Fe, Ni, Cr, lanthanides, Ce, Al, Ga, In, and Tl. The counter-cation “Y” is preferably independently selected from the group consisting of H, Zn, Co, Cu, Bi, Na, Li, K, Rb, Cs, Ba, Mg, Sr, ammonium, C₁₋₁₂-alkylammonium, and C₁₋₁₂-alkylamine.

More preferred POMs are of the formula [Y]ⁿ⁺[XM₁₂O₄₀]ⁿ⁻, where “Y,” “X,” “M,” and “n” are as is as defined above. The most preferred POMs are of the formula [y]ₙ+[XM₁₂O₄₀]ⁿ⁻, wherein “Y” and “n” are as defined above, “X” is Si, P, or Ge, and each “M” is independently selected from Mo, W, or V. The most preferred POM is H₃PMo₁₂O₄₀.

Examples of POMs that can be used in the invention and how to synthesize the POMS are disclosed in Pope (1983) Heteropoly and Isopoly Oxometalates, Springer, Berlin; and Pope (1998) Chemical Reviews 98:1-389 and in U.S. Pat. No. 4,916,101 (incorporated herein). Briefly, POM acids of the preferred formula [Y₃₋₁₈]ⁿ⁺[X₁₋₄M₁₋₃₆O₁₀₋₆₀]ⁿ, where “Y” is hydrogen can be fabricated by treating the corresponding anion (in aqueous solution) with a tetraalkylammonium halide to form the tetraalkylammonium salt. The salt decomposes at elevated temperature to yield the corresponding POM acid (with hydrogen as the “Y” moiety). The process is straightforward and can be accomplished-using standard laboratory equipment.

The first step in the in the synthesis is to convert a reactant POM salt (normally the sodium, potassium, lithium or ammonium salt) to the tetraalkylammonium salt form by reacting it with tetraalkylammonium halide. The alkyl group in the tetralklyammonium halide is preferably a C₁₋₇ alkyl, such as methyl, ethyl, propyl, butyl, pentyl, hexyl, heptyl, isomeric forms of any of the foregoing and mixtures thereof. The preferred alkyl is n-butyl because of its ready commercial availability. The halide is chloride, bromide, iodide or fluoride. The reaction is an ordinary displacement reaction.

In practice, an aqueous solution of the POM reactant salt is mixed at 50° C. with an aqueous solution of the tetralklyammonium halide for 15 minutes. The mixture is then refrigerated at 4° C. overnight, which causes the tetralklyammonium POM to crystallize from solution. The tetralklyammonium POM is recovered by filtration in about 70% yield. Heating the tetralklyammonium POM at 500° C. for one hour causes it to decompose to the POM acid. The POM structure can be confirmed by infrared spectrophotometry. Thermal gravimetric analysis during the course of the pyrolysis confirms that the tetrabutylammonium groups are eliminated under the pyrolysis conditions.

A variety of structures are known for these materials; they can have, for instance, the so-called Keggin structure, wherein twelve MoO₆ octahedra surround a central PO₄ tetrahedron (in the case where phosphorus is the heteroatom and molybdenum is the addendum or poly atom). Other structures and related formulas are also known. The central atom of the Keggin structure, which is typically phosphorus, can also be (without limitation) any of the Group 111A to Group VIIA metalloids or any non-transition metals, including (without limitation) P, As, Si, Ge, B, Al, Sb, and Te. The poly atom, as noted earlier, can be (without limitation) any of the Group VB or VIB transition metals, including W, V, Cr, Nb, Mo, or Ta. Thus suitable materials for use in the present invention include preferably phosphomolybdates, phosphotungstates, silicomolybdates, and silicotungstates. Other combinations selected from among the above elements are also possible, including borotungstates, titanotungstates, stannotungstates, arsenomolybdates, teluromolbydates, aluminomolybdates, phosphovanadyltungstates, and the like, the latter representing a mixed material having a formula (for the anion portion) of PW₁₁VO₄₀. The preferred material is a phosphomolybdate, which term encompasses both the acid and salt forms of the POM.

The POMs can be used in their acid form (wherein the anion is associated with the corresponding number of hydrogen ions), in the fully salt form (wherein the hydrogen ions of the “Y” group have been replaced by other cations such as metal ions), or in the partially exchanged salt form (wherein a portion of the hydrogen ions have been thus replaced). Thus the “Y” moiety of the POM can be a partially or fully exchanged with cations from the elements in Groups IA, IIA, IIIA, IB-VIIIB, of the periodic table, including manganese, iron, cobalt, nickel, copper, silver, zinc, boron, aluminum, bismuth, or ammonium or hydrocarbyl-substituted ammonium salt. Alkali metals include the metals in Group IA of the periodic table, especially sodium, potassium, and cesium. Alkaline earth metals include metals in Group IIA of the periodic table, especially magnesium, calcium, and barium. The exact stoichiometry of these materials will depend on the identity of the metals and metalloids employed in their structure. For more detailed information on the structures of POMs, see Misono (1987) “Heterogeneous Catalysis by Heteropoly Compounds of Molybdenum and Tungsten,” Catal. Rev.-Sci. Eng., 29(2&3): 269-321 (in particular, see pages 270-27 and 278-280).

Heteropoly acids are commercially available from, among others, Aldrich: [H₃]; [PW₁₂O₄₀].xH₂O), ie., “phosphotungstic acid hydrate,” is Aldrich catalog no. 22,420-0; [H₃] [PMo₁₂O₄₀].xH₂O, i.e., “phosphomolybdic acid hydrate,” is Aldrich catalog no. 22,185-6. The salts are similarly commercially available. Alternatively, they can be prepared from the acid materials by neutralization with an appropriate amount of base. The product is isolated by evaporation of the excess water.

POM acids are generally received in a hydrated form. They can be successfully employed in this form (uncalcined) or they can be treated (calcined) to remove some or all of the water of hydration. The dehydrated species usually exhibits improved reactivity. Calcining is accomplished by simply heating the hydrated material to a suitable temperature to drive off the desired amount of water. The heating can be under ambient pressure or reduced pressure, or it can be under a flow of air or an inert gas such as nitrogen. The calcining is preferably conducted in air at a temperature of at least 150° C., preferably at least 200° C., and more preferably still at least 250° C. The presence of air ensures that the POM acid is in a high oxidation state. The length of time required for calcining is related to the equipment and scale, but at the laboratory level the calcining typically takes at least 30 minutes, and generally 3 to 5 hours. See also U.S. Pat. No. 5,710,225 (incorporated herein).

Method to Deplete CO from an Incoming Gas and to Generate Electricity:

A first embodiment of the invention is a process that bypasses the WGS reaction during the production of fuel cell-grade H₂ by using CO as an additional source of energy from H₂ streams. This process is especially promising for producing electrical energy from renewable biomass-derived oxygenated hydrocarbons. This is because these reactants have C:O stoichiometric ratios of 1:1. Therefore these reactants generate H₂ and CO in nearly equal amounts during catalytic decomposition.

The inventive method for selectively oxidizing of CO comprises reacting CO and liquid water with a reducible POM compound in solution, such as an aqueous solution of H₃PMo₁₂O₄₀. The POM functions in a dual fashion: first as a selective and powerful oxidizing agent for CO; and, second as an energy storage agent for electrons and protons. The reaction takes place over a metal-containing catalyst, preferably a transition metal-containing catalyst (including the inner transition metals), and more preferably a Group VIIEB or Group IB metal-containing catalyst, more preferably still a noble metal-containing catalyst, and most preferably gold nanotube- or gold nanoparticle-containing catalyst. The preferred embodiment of the invention method takes advantage of the high catalytic activities of gold nanoparticles for CO oxidation (11-13), especially in the presence of liquid water (14, 15).

Of particular note is that the inventive method can take place at room temperature (i.e., 30° C. or less). In contrast, the WGS reaction must be operated at elevated temperatures (at least 400 K and typically above 500 K) (6, 16). In the present invention, CO is removed from the gas stream by oxidizing it to CO₂, thereby forming an aqueous solution of reduced POM species. A representative reaction is as follows:
CO_{(g)}+H₂O₍₁₎+PMo₁₂O₄₀³⁻_{(aq)}→CO_{2(g)}+2H⁺_{(aq)}+PMo₁₂O₄₀⁵⁻_{(aq)}

The POM solution contains stored energy in the form of protons and electrons associated with reduced metal cations. It is much preferred in the present invention that the POM be capable of undergoing oxidation-reduction reactions reversibly. In this fashion, the reduced POM is re-oxidized readily at a fuel cell anode. At the anode, electrons are transferred from the reduced POM to the electrode, and protons are transported through the proton exchange membrane (PEM) to the cathode. Thus, the present method for oxidizing CO not only removes CO from gas streams for fuel cells, but the process also converts the energy content of CO into a liquid that itself can subsequently be used to power a fuel cell. Thus, whereas previous studies of CO oxidation have used irreversible oxidizing agents such as O₂ (17, 18), the present invention uses aqueous-phase POM compounds that undergo reversible oxidation-reduction reactions.

In short, the reversibly reducible POM compound facilitates CO removal by being reduced. The reduction of the POM simultaneously oxidizes the CO to CO₂. The reduced POM then serves as a fuel for generating electrical energy by undergoing oxidation at a fuel cell anode. Thus, the use of the POM species as oxidation-reduction shuttle eliminates the need to convert CO to gaseous H₂ and CO₂ in hydrogen gas streams destined to be used as fuel for fuel cells. Thus, the present invention eliminates the need for an onerous intermediate reaction (the WGS reaction) that is required to remove CO from H₂ gas streams.

As an illustration of the utility of the present invention, consider generating electricity using ethylene glycol as a fuel source. Ethylene glycol decomposes according to the stoichiometric reaction:
C₂O₂H₆₍₁₎→2CO_{(g)}+3H_{2(g)}
This reaction can be carried out using a supported catalyst (for example, 3 wt % Pt/Al₂O₃), with CO and H₂ selectivity of 90% or greater, and with 50% conversion of ethylene glycol at a reaction temperature of about 500 K. Ethylene glycol dissociation is endothermic (234 kJ mol⁻¹) and requires combustion of 0.83 moles of CO for an energetically neutral process to produce 3 moles of H₂ and 1.17 moles of CO. The CO so produced will be used in the present invention for producing electrical energy.

If the H₂ and CO are separated, then the H₂ can be sent to a PEM fuel cell operating at 50% efficiency, and 0.83 moles of CO will be combusted (see prior paragraph). The remaining 1.17 moles of CO can then be converted to electrical energy according to the present invention. When operating the fuel cell at 0.35 V (as shown in the Examples, corresponding to approximately 25% of the standard Gibbs free energy change for CO combustion), the overall efficiency for producing electricity from the ethylene glycol fuel via the present invention is equal to 40%.

Of significant advantage, the present method does not require the use of water as a reactant, as would be needed for ethylene glycol reforming (2, 3):
C₂O₂H₆₍₁₎+2H₂O₍₁₎→2CO_{2(g)}+5H_{2(g)}
In this respect, it is important to recognize that the energy content of liquid ethylene glycol is about 20 kJ cm⁻³ (equal to 60% of the value for octane), while the energy content of a stoichiometric liquid mixture of ethylene glycol and water is about 10 kJ cm⁻³. In contrast, the energy density of H₂ at a pressure of 690 bar (10,000 psi) is only equal to about 7.5 kJ cm⁻³. Thus, the ethylene glycol fuel has a significantly increased energy density than highly compressed molecular hydrogen. Moreover, the ethylene glycol fuel is non-flammable and can be stored safely, at ambient temperature and pressure.

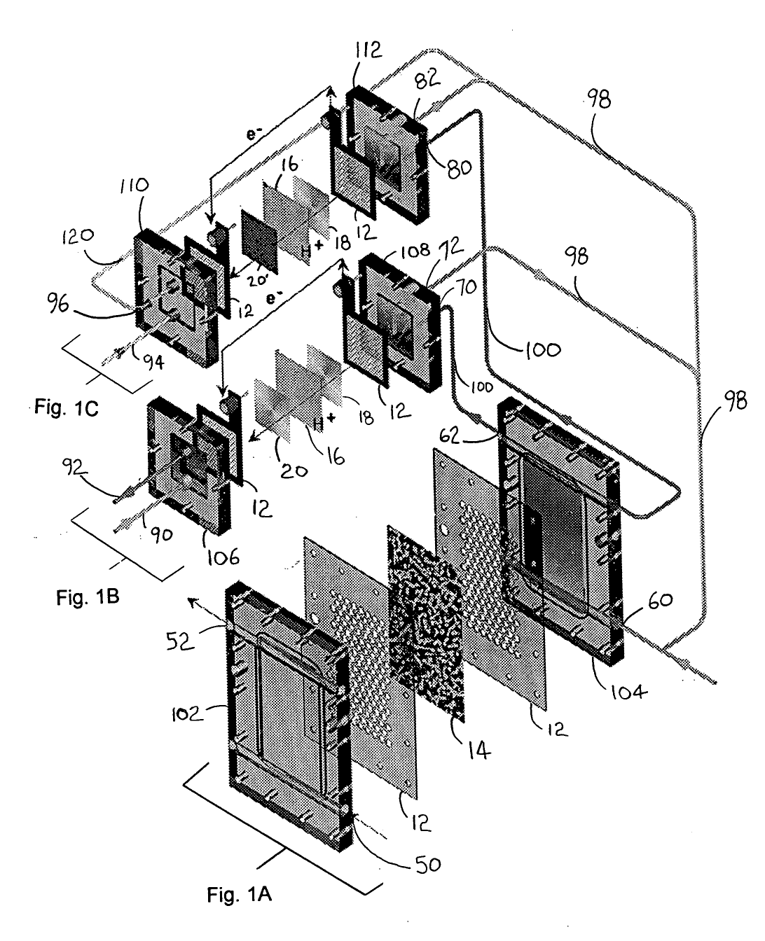

FIG. 1A shows a schematic representation of the reactor system used to study the reduction of aqueous solutions of POM compounds by CO in a gold nanotube membrane reactor. FIGS. 1B and 1C further illustrate two types of fuel cells that can be powered using the reduced POM fuel. As described herein, most of the initial studies were carried out using aqueous solutions of H₃PMo₁₂O₄₀ (which has the Keggin structure, namely a central tetrahedral PO₄ surrounded by twelve octahedral MoO₆ (19)). This POM is yellow in color, and stable in solid form at temperatures up to about 473 K.

FIG. 1A illustrates the preferred reactor according to the present invention. The reactor is dimensioned and configured to oxidize CO to CO₂, while simultaneously generating a solution containing a reduced form of a POM. The reactor shown in FIG. 1A includes a gas reaction chamber 102, having a CO inlet 50 and a CO₂ outlet 52, and a liquid reaction chamber 104 having an oxidized POM solution inlet 60, and a reduced POM solution outlet 62. Sandwiched between the two reaction chambers 102 and 104 are a pair of porous metal plates 12 that flank and support a membrane catalyst 14. In operation, the two chambers 102 and 104 are clamped together, face-to-face, so that both chambers allow reactants to contact the membrane catalyst 14.

In operation, the two chambers 102 and 104 are first purged with nitrogen. An aqueous solution of an oxidized POM is then pumped into the liquid reaction chamber 104 via inlet 60. A gas stream containing CO (preferably a gas stream containing H₂ and CO) is then pumped into the gas reaction chamber 102 via inlet 50.

The membrane catalyst comprises a metal, preferably gold and most preferably nanotubular gold or nanoparticulate gold. When the CO in chamber 102 is contacting one side of the membrane catalyst 14, at the same time the oxidized POM solution is contacting the other side of the membrane catalyst, a highly selective catalytic redox reaction takes place wherein the CO is oxidized to CO₂ and the oxidized POM in solution is reduced. This has the effect of removing CO from the incoming gas stream. The resulting gas, now depleted of CO, is vented from the reactor at outlet 52. Simultaneously, the reduced form of the POM is vented from the reactor at outlet 62. Thus, the device illustrated in FIG. 1A is dimensioned and configured to accomplish two ends: to remove CO from the inlet gas, and to generate a solution comprising a reduced POM. If the CO-depleted gas comprises hydrogen, the CO-depleted gas exiting the reactor at 52 can be used to fuel a PEM fuel reactor. Moreover, the solution of reduced POM exiting at 62 can also be re-oxidized at the anode of a PEM fuel cell.

FIGS. 1B and 1C illustrate preferred fuel cells that can be operationally linked to the reactor shown in FIG. 1A. Taken together, FIGS. 1A and 1B, and FIGS. 1A and 1C illustrate devices according to the present invention for generating energy from gas streams containing CO.

Specifically, FIG. 1B is a fuel cell in which the reactions taking place at both the anode and the cathode are redox reactions of the aqueous POM solution. By using the reduced POM solution generated by the reactor of FIG. 1A, energy can be generated by alternatively (and reversibly) oxidizing and reducing the POM solution (at the anode and cathode, respectively). As shown in FIG. 1B, the fuel cell is of largely conventional design. Reaction chambers 106 and 108 are shown. The reaction chambers flank a pair of opposed collector plates 12, which in turn sandwich an anode 18 and a cathode 20. A proton exchange membrane (PEM) 16 is disposed in the center of the fuel cell. The arrow marked “e-” in FIG. 1B shows the direction of electron flow in the fuel cell. The PEM defines a proton-permeable barrier between chambers 106 and 108.

In operation, the reduced POM solution exiting the reactor of FIG. 1A (at outlet 62) is input into one half of the fuel cell (the anode half) at inlet 70 (via conduit 100). At the same time, a solution of oxidized POM solution is input into the other half of the fuel cell (the cathode half) at inlet 90. The reduced POM entering at inlet 70 is oxidized at the anode 18. The now re-oxidized POM solution exits the reactor at outlet 72, and is re-circulated (via conduit 98) back to the reactor of FIG. 1A. In the other half of the fuel cell shown in FIG. 1B, the oxidized POM solution is reduced at the cathode 20. The reduced POM solution exits the fuel cell at outlet 92. The reduced POM solution exiting at 92 can be sent to the anode inlets 70 and/or 80 (see FIG. 1C) for re-oxidation. Preferably this reduced POM exiting at 92 is regenerated by re-oxidation with O₂ or O₂ in air. The entire process generates an electron stream as shown in FIGS. 1B and 1C that can do work, and causes protons to pass through the PEM 16. So long as a CO-containing gas stream is continuously fed into inlet 50, the POM solution can be re-circulated indefinitely between the reactor shown in FIG. 1A and the fuel cell shown in FIG. 1B. Thus, the combined device shown in FIGS. 1A and 1B both removes CO from an incoming gas stream and uses the CO (indirectly) to generate electrical energy.

Alternatively, rather than using the oxidized POM solution in the cathode half of the fuel cell, molecular oxygen can be used as the oxidizing agent, as shown in FIG. 1C. The fuel cell shown in FIG. 1C is substantially identical to that shown in FIG. 1B. In FIG. 1C, reaction chambers 110 and 112 are shown. The reaction chambers flank a pair of opposed collector plates 12, which in turn sandwich an anode 18 and a cathode 20′. A proton exchange membrane (PEM) 16 is disposed in the center of the fuel cell. The arrow marked “e-” in FIG. 1C shows the direction of electron flow in the fuel cell. The PEM defines a proton-permeable barrier between chambers 110 and 112.

In operation, the reduced POM solution exiting the reactor of FIG. 1A (at outlet 62) is input into one half of the fuel cell (the anode half) at inlet 80 (again via conduit 100). At the same time, rather than inputting oxidized POM into the cathode half of the fuel cell, molecular oxygen (O₂) is pumped into chamber 110 via inlet 94. The reaction at the anode half of the fuel cell is the same as in FIG. 1B: the reduced POM is oxidized, and exits chamber 112 at outlet 82. The now-oxidized POM solution is directed back to the reactor of FIG. 1A via conduit 98. In the cathode half of the fuel cell shown in FIG. 1C, the oxygen is reduced by protons passing through the PEM 16 and electrons, to yield water, which exits the cathode half of the fuel cell at outlet 96. The water is carried by conduit 120, and subsequently re-united with the POM solution at the junction of conduits 120 and 98 (at the right-hand side of FIG. 1C). The water is thus re-circulated back to the reactor shown in FIG. 1A.

Reacting the aqueous POM solution with CO over a gold catalyst leads to the formation of CO₂ and a reduced aqueous POM solution that has a characteristic deep blue color. The color change (from yellow to blue) is caused by charge transfer between Mo⁵⁺ and neighboring Mo⁶⁺ species (20).

The reduction of H₃PMo12O₄₀ by CO does not take place at room temperature without the catalyst.

The aqueous solution containing the reduced POM was then delivered to a fuel cell constructed with an anode fashioned from a gold nanotube membrane or made from a simple carbon-like graphite without any precious metal. The cathode of the fuel cell was comprised of Pt supported on carbon for cases where O₂ was used as the oxidizing agent (FIG. 1C). For cases where the oxidizing agent was an aqueous solution of oxidized H₃PMo₁₂O₄₀ in this illustration, the cathode was comprised of a gold nanotube membrane or made from carbon (FIG. 1B). Oxidized POMs comprising PVₙMo₁₂₋ₙO₄₀⁽³⁺ⁿ⁾⁻ with n=1 to 6 are promising in these cases, because reduced POMs comprising V and Mo are readily re-oxidized by just contacting with air.

Of particular note is that in the case of FIG. 1B, wherein the POM solution is both the oxidizing agent and the reducing agent (that is, reduced POM enters the anode half of the fuel cell and is oxidized; while oxidized POM enters the cathode half of the fuel call and is reduced), the fuel cell is completely precious metal-free. The fuel cell will function with electrodes (both anode and cathode) made from carbon. In this arrangement, oxidation of the reduced POM solution at the anode in the fuel cell does not require a precious metal electrode because the protons and electrons have already been separated during the CO oxidation step over the gold catalyst in the reactor depicted in FIG. 1A.

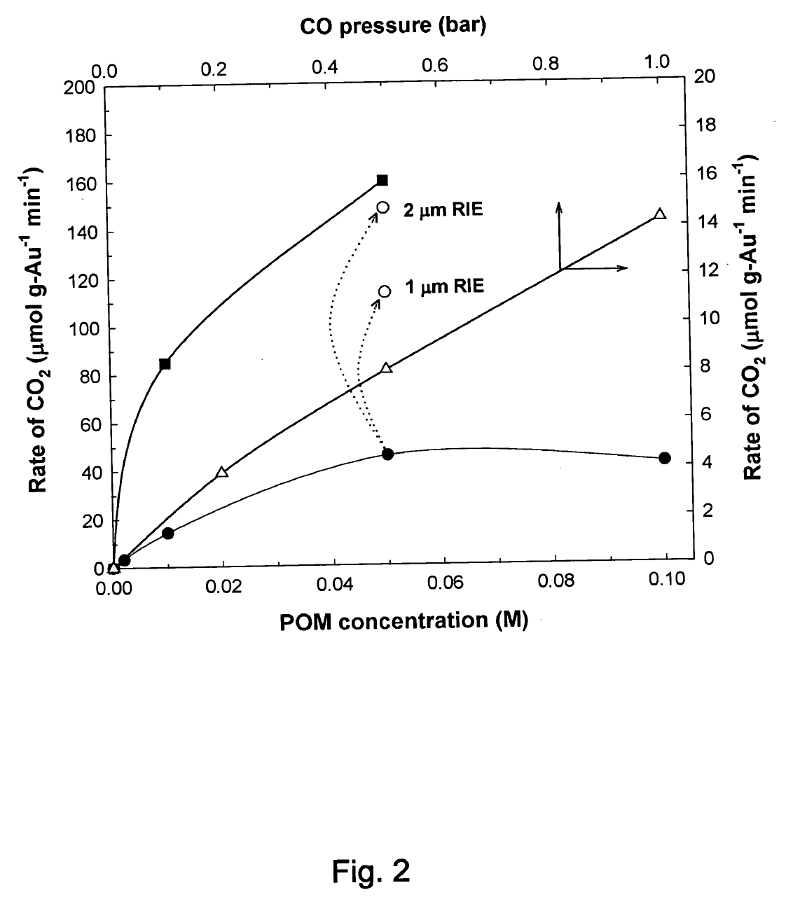

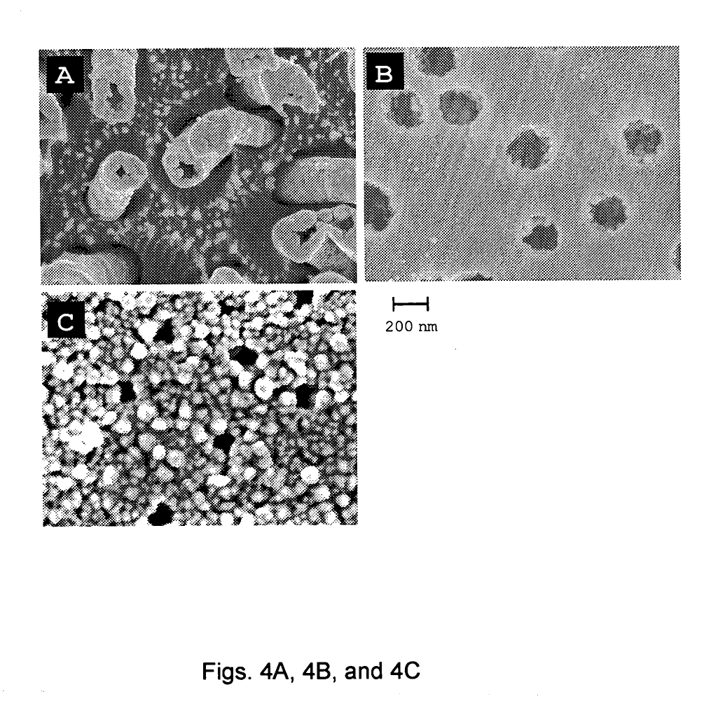

Using the reactor illustrated in FIG. 1A, the rate of CO₂ production (see FIG. 2) with aqueous solutions of POM compounds on gold nanotube membranes increases with the concentration of the aqueous POM solution up to about 0.05 M. The rate is first order with respect to the partial pressure of CO in the gas stream. (Scanning electron microscopic images of the gold nanotubes present in the catalyst are shown in FIGS. 4A, 4B, and 4C.)

The graph presented in FIG. 2 shows the rate of CO₂ production (i.e., the rate of CO oxidation) as a function of POM concentration (H₃PMo₁₂O₄₀) using gold nanotube membranes at 298 K and a total pressure of 1 bar (using a reactor as shown in FIG. 1A). FIG. 2 presents the POM concentration (M) on the X axis and rate of CO₂ production on the Y-axis (μmol per gram of gold per minute). The results for a catalytic membrane prepared by electroless deposition of gold for 2 hours vs. POM concentration is shown by the filled circles, -●-, CO₂ production as a function of CO partial pressures (with the POM concentration held steady at M=0.01 is shown by the empty triangles, -Δ-. The corresponding values after the membrane was etched by RIE treatment to remove 1 and 2 μm of membrane is shown by the empty circles, -∘-. The rate of CO₂ production for a membrane prepared by electroless deposition of gold for 0.25 h versus POM concentration is shown by the filled squares, -▪-. FIG. 2 demonstrates that the reactor generates CO₂ in proportion to both POM concentration (at least up to about 0.5 M POM; -●- and -▪-). FIG. 2 also demonstrates that the reactor generates CO₂ in proportion to CO partial pressure (at least up to about 0.5 bar; -Δ-). Lastly, FIG. 2 shows that etching the membrane upon which the gold nanotube catalyst is disposed increases the rate of CO₂ production; -∘- (presumably by exposing more catalytic surfaces).

The rate is enhanced significantly when the gold nanotubes within the track-etched pores of polycarbonate template (see Examples and FIG. 2) were exposed from the polycarbonate to a depth of 1 to 2 μm by selectively etching the membrane using reactive ion etching (RIE) with an O₂ plasma (22). The rate of CO oxidation per gram of gold is greater for membranes containing smaller amounts of gold because the average particle size of gold is smaller for these materials, thus leading to higher surface areas per gram of gold. This result indicates that the rate of CO oxidation can be altered by changing the morphology of the gold catalyst, for example, by changing the inner and/or outer pore diameters of the gold nanotubes.

Catalysts comprising metal-containing (preferably gold) nanoparticles on various supports can achieve high rates of CO oxidation using aqueous solutions of POM compounds. Gold catalysts in particular have been shown to exhibit high rates of CO oxidation by O₂ (17, 18) or by H₂O (6, 23) at low temperatures. The present inventors have demonstrated very high rates of CO oxidation by aqueous solutions of H₃PMo₁₂O₄₀ over nanoparticles of gold supported on carbon or titania using gold catalysts provided by the World Gold Council (see the Examples). Typically, these experiments were carried out at 298 K in a pressurized batch reactor at a CO pressure of 15 bar with 20 cm³ of 0.05 M POM solution. The rate of CO₂ production at low conversions was approximately 16×10⁴ μmol g Au⁻¹ min⁻¹ (˜3500 cm³ at 273 K and 1 bar of gaseous CO₂ produced per gram of gold per minute). This is equivalent to a turnover frequency (TOF) of 4.3 s⁻¹, assuming a gold dispersion of 12% based on the average diameter of the gold particles (7 to 10 nm) on carbon. This high specific rate achieved by the present invention, even at room temperature, is comparable or even faster than rates of CO oxidation by O₂ over supported gold catalysts at 353 K (30×10⁴ μmol gAu⁻¹ min⁻¹) (24) and rates of WGS over cyanide-leached gold catalysts at 523 K (3.7×10⁴ μmol gAu⁻¹ min⁻¹) (6).

The rate of CO₂ production and TOF are very high at pressures near 1 bar (approximately 3×10⁴ μmol gAu⁻¹ min⁻¹, see Table 5), indicating that the present invention can be applied to gaseous streams produced from a conventional catalytic reforming of hydrocarbons, without involving the WGS reaction as an intermediate step to remove CO. Moreover, it has been observed that the rate of CO oxidation by the present method is ten-fold faster than the rate of H₂ oxidation when both gases are passed separately over a gold catalyst. The rate of CO oxidation in the present invention is at least an order of magnitude faster than the rate of H₂ oxidation when using a CO:H₂ gas mixture containing 10% CO. The rate of H₂ oxidation was measured by monitoring the color change of the POM solution using a UV-visible spectrometer operating at 500 rm. These results indicate that the present invention can be used to remove CO from H₂ gas streams for fuel cell applications.

The highest energy density obtained in the Examples was 2.5 moles of CO₂ produced per liter of solution containing H₃PMo₁₂O₄₀ at a concentration of 1 M. This corresponds to 5 electrons per Keggin unit. This extent of storage was achieved using a pressurized batch reactor containing the solution of POM compound with gold nanoparticle catalysts, operating at room temperature and a CO pressure of 15 bar. The extent of POM reduction calculated from the CO₂ production agreed within 20% with the extent of reduction measured by integrating the electrical current versus time produced when the reduced solution was completely re-oxidized in a fuel cell discharged at constant resistance, and dividing this value by the Faraday constant. (See Table 6 in the Examples for details).

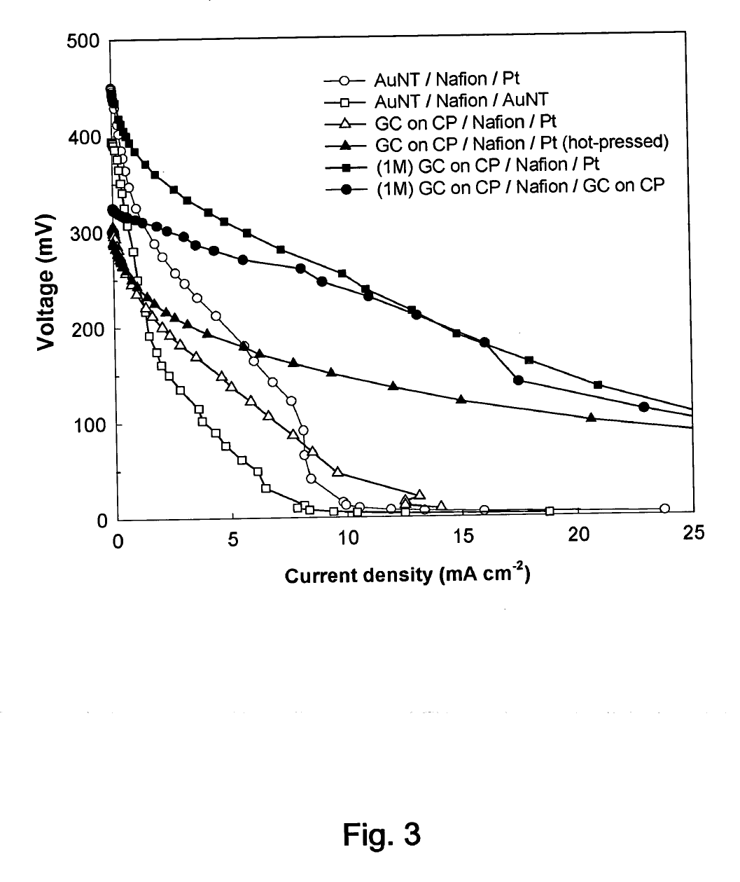

Generating power using reduced POM solutions (produced from CO oxidation) is not limited to conventional electrodes (e.g., Pt-based). FIG. 3 shows curves of voltage versus current density from a single cell for various combinations of anodes, cathodes, and reduced POM solutions. Reduced H₃PMo₁₂O₄₀ solution was used as a fuel to generate the data in FIG. 3. As an oxidant, O₂ was used for the Pt cathode and oxidized H₃PMo₁₂O₄₀ was used for gold or carbon cathodes. All curves were obtained using 0.5 M H₃PMo,20₄₀, except the filled squares and circles, which used a 1 M solution. AuNT=gold nanotube membrane deposited for 2 h with surface gold; Pt=Pt/C cathode; GC=graphitic carbon; CP=carbon paper. Legend: (-◯-)=AuNT/Nafion® PEM/Pt; (-□-)=AuNT/Nafion® PEM/AuNT; (-Δ-)=GC on CP/Nafion® PEM/Pt; (-▴-)=GC on CP/Nafion® PEM/Pt (hot-pressed); (-▪-)=1 M GC on CP/Nafion® PEM/Pt; (-●-)=1 M GC on CP/Nafion® PEM/GC on CP.

Although higher current densities (by 20 to 50%) are achieved using electrodes containing precious metals (e.g., Pt, Au) with a Nafion® proton exchange membrane (21), it can be seen that good current densities can be generated using a simple carbon anode. Good current densities can be generated even when the Pt-containing cathode used with O₂ is replaced by a simple carbon cathode used with oxidized H₃PMo₁₂O₄₀. The data in FIG. 3 thus show that the present invention can be used to generate electricity in a fuel cell devoid of precious metal electrodes.

Conventional hydrogen PEM fuel cells operating with Pt-based electrodes have current densities higher than 100 mA cm⁻². However, these fuel cells have been highly optimized, and they require precious metals to oxidize H₂ at the anode and to reduce O₂ at the cathode. The present invention demonstrate the ability to make new generations of inexpensive fuel cells that operate with solutions of reduced POM compounds and that have current densities of at least 10 mA cm².

This current density was increased three-fold at 100 mV and four-fold or greater at 50 to 100 mV when the sub-assembly of the carbon anode, the Nafion® PEM, and the Pt cathode was treated by hot-pressing at 400 K, as shown in FIG. 3 (-▴-). (Specifically, compare the empty triangles versus the filled triangle). Thus, further optimization of these new fuel cells will lead to improved current densities and improved utilization of precious metals at the electrodes.

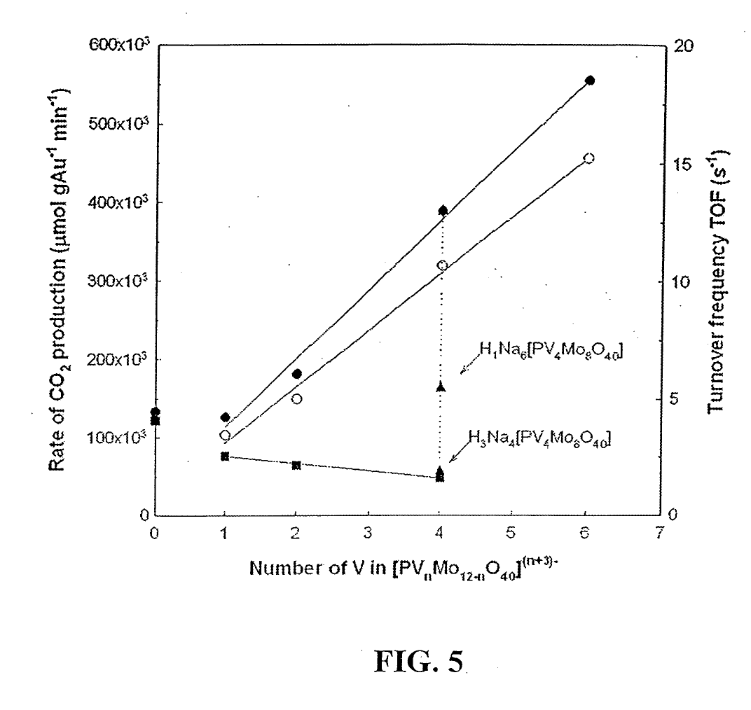

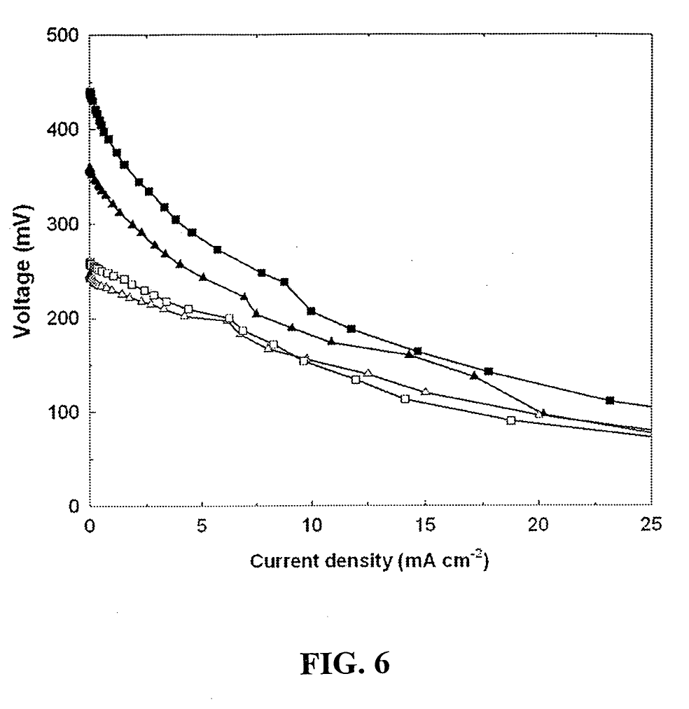

FIGS. 5 and 6 are graphs showing reaction rates of CO oxidation and voltage-current curves, respectively, using various [PVₙMo₁₂₋ₙO₄₀]⁽ⁿ⁺³⁾⁻ POM anions. FIG. 5 shows results of CO₂ production rates at room temperature over a number of the V-Mo based Keggin POMs synthesized here. As the number of V cations increased from 1 to 6 in the Na salt POMs, the CO₂ production rate increased linearly up to 550,000 μmol gAu⁻¹ min⁻¹. However, for the acid POMs (filled squares), the rate appeared to decrease slightly with the number of V cations. For the POMs with four vanadium cations in the Keggin unit, the CO oxidation rate was enhanced as H+ cations were exchanged by Na⁺ cations, as seen in the vertical line at V=4.

The POMs reduced by CO were delivered to a simple carbon anode in modified fuel cells with a Pt-based or simple carbon cathode, depending on whether the oxidant at the cathode side was O₂ or oxidized POMs, respectively. FIG. 6 shows voltage-current density curves from a single cell for the POM solutions reduced by CO. Nafion®-brand membrane was sandwiched by a simple carbon anode and a Pt/C cathode, or by two carbon electrodes, followed by hot-pressing at 403 K for 5 h to facilitate mass transfer between the membrane and electrodes. Good current densities were generated using the Pt cathode with O₂. When the Pt cathode was replaced with a simple carbon cathode to which oxidized H₇[PV₄Mo₈O₄₀] or H₅[PV₂ Mo₁₀O₄₀] was fed, good current densities could be obtained. It is noteworthy that the latter case has a practical advantage in that it does not involve any precious metals in the fuel cell system. Additionally, in this embodiment, the reduced POM at the cathode can be reoxidized by exposure to air and then recycled back to the cathode continuously.

Thus, the room temperature process disclosed herein has several practical implications for hydrogen production, purification, storage and utilization: 1) efficiently and quickly removing CO from CO-containing streams (by oxidizing CO to CO₂); 2) harnessing the energy content of CO in a CO-containing stream by adding a fuel cell process, 3) improving energy transfer efficiency for fuel cell applications using a CO and H₂-containing gaseous mixture that can be produced from the conventional catalytic reforming of hydrocarbons; and 4) employing an inexpensive fuel cell made of simple carbon electrodes that are devoid of any precious metals.

### EXAMPLES

The following Examples are included solely to provide a more complete description of the invention disclosed and claimed herein. The Examples do not limit the scope of the invention in any fashion.

Materials:

Activated Carbon Fibers (ACF) were in the form of a woven fabric that was purchased commercially (“Kothmex”-brand fibers from Taiwan Carbon Technology Co., Taichung, Taiwan, catalog no. AW 1104.). This fabric is 100% woven ACF, has a density of 150 g/m², and a nominal thickness of 0.5±0.1 mm. Its surface area, as measured by the Brunner-Emmett-Teller (BET) method, is 1100 m²/g, with an average pore size of 19-20 Å.

“E-Tek”-brand carbon cloth was purchased from De Nora North America, Inc., Somerset, N.J. The fabric is a plain weave, has a density of 116 g/m², and a nominal thickness of 0.35 mm. The fabric is non-wet proofed. Lot no. 9615 was used in the Examples.

All gasses (hydrogen, helium, oxygen, etc.) were purchased from AGA Gas, Inc, Cleveland, Ohio (acquired in January 2004 by Linde Gas LLC, Cleveland, Ohio and now doing business under the Linde name).

“Toray”-brand carbon Paper (catalog no. B-2/TGPH-120, was also purchased from De Nora North America, Inc.). It has a nominal density of 0.49 g/cm³, and a nominal thickness of 0.35 mm. The paper is non-wet proofed. Lot no. 748C was used in the Examples.

“Spectracorp”-brand carbon paper (catalog no. B-3/2050A-2050, was also purchased from De Nora North America, Inc.). The paper has a nominal density of 0.50 g/cm³, and a nominal thickness of 0.51 mm. The paper is non-wet proofed. Lot no. 12021 was used in the Examples.

“Spectracorp”-brand “Macroporous Flow Field” carbon paper was purchased from De Nora North America, Inc. (catalog no. B-4/2050A-2025). The “Marcoporous Flow Field paper has a nominal density of 0.25 g/cm³, and a nominal thickness of 0.51 mm. The paper is non-wet proofed. Lot no. 47021 was used in the Examples.

“Black Pearls 2000”-brand carbon black was purchased from Cabot Corp., Alpharetta, Ga. Lot no. GP-3821 was used in the Examples.

“Ultra F Purity”-brand graphite was purchased from Carbone of America, Ultra Carbon Division, Bay City, Mich.

The carbon-supported gold catalyst (Au/C) used in the Examples was a gold standard catalyst purchased from the World Gold Council (Type D, Lot #4D). The catalyst was characterized by the vendor as 0.8 wt. % Au by atomic absorption/inductively coupled plasma (AA/ICP) emission prepared on an X40S carbon support. The average Au particle diameter as measured by tunneling electron microscopy (TEM) was 10.5 nm. The estimated Au particle diameter as measured by x-ray powder diffraction (XRPD) was 6.7 nm.

Filtered, de-ionized liquid water (H₂O) was made on site using “Millipore”-brand equipment (Billerica, Mass.).

Hydrogen tetrachloroaurate (III) trihydrate (HAuCl₄*3H₂O) (99.9+%), ethylenediamine (C₂H₄(NH₂)₂) (99+%), and anhydrous ether (C₂H₅₀C₂H₅) (99.7+%) were purchased from Aldrich. Ethanol (C₂H₅OH) was purchased from Fisher Scientific International, Inc., Hampton, N.H.

Activated carbon-supported platinum catalyst (Pt/C) was purchased from Aldrich and was characterized by vendor as 10 wt. % Platinum.

Poly(vinyl alcohol) (PVA, C₂H₃OH), 98% hydrolyzed, was purchased from Aldrich. Typical M_{w}=13,000 to 23,000. Freezing point=113° C. Melting point=300° C.

Poretics®-brand track-etched polycarbonate membranes were purchased from General Electric Water & Process Technologies, Trevose, Pa. (formerly GE Osmonics, Inc.).

Methods:

Ethylenediamene Gold ([Au(en)₂]Cl₃) Solution. Ether (5 mL) was added to ethylenediamine (1 mL) and this solution was mixed with a second solution of hydrogen tetrachloroaurate(III) trihydrate (1 gram) dissolved in ether (10 mL). A yellow precipitate formed and the supernatant removed. The precipitate was then dissolved in water (2.8 mL). Addition of ethanol (20 mL) to this solution resulted in the formation of solid white precipitate crystallites. The supernatant was removed and the crystallites redisolved in water to yield appropriate [Au(en)₂]Cl₃ stock solutions.

Platinum precursor salt solutions were prepared from a tetraamine platinum(II) nitrate (Pt(NH₃)₄(NO₃)₂ salt (Aldrich) salt, dissolved in filtered, de-ionized water.

Platinum precursor salt solutions in water were also prepared from chloroplatinic acid hexahydrate (H₂PtCl₆*6H₂O) (Strem Chemicals Inc., Newburyport, Mass.

Pelletizing: A specimen mount press (Buehler Ltd., Lake Bluff, Ill.) was used for pressing reduced catalysts, graphite, and black pearls into pellets for use as electrodes on the various supports. A pressure of 10,000 pounds per square inch (psi) was applied for time periods ranging between about 10 minutes to about 30 minutes. As the pressure in the mount press decreased with the settling of particles, the specimen mount press pressure was adjusted to maintain the applied pressure at 10,000 psi. Pellets were made using either a circular die set (3.1 cm diameter) or two 10 cm×10 cm stainless steel, polished plates. The pellet thicknesses depended upon the mechanical stability of the material being pressed. In general, the pellets where made as thin as possible. Occasionally a piece of weighing paper was used as a release liner between the metal dies and the pellet (to facilitate removing the finished pellets from the press). Electrodes with varying supports and support/catalyst mixtures (as described herein) were made using this protocol.

Aqueous Impregnation: The various supports were impregnated with carbon or precious metal catalysts by immersing the supports in an aqueous solution of either graphite, black pearls, platinum, or gold solutions (prepared as described above). The supports were immersed in stirred solutions (using a stir bar and stir plate) for about an hour or until a color change (yellow to clear) was observed. Occasionally gentle heating (on a hot plate) or rotary evaporation was employed to remove excess water. The supports were then washed with filtered, de-ionized water and dried at room temperature.

The samples were then activated by a heat treatment in flowing hydrogen (100 cm³ (normal temperature and pressure, NTP)/min). The hydrogen stream was heated using a linear temperature ramp (4.6 K/min) for 1 hour to a final reduction temperature of 573 K. The catalysts were held at this reduction temperature for half an hour in the flowing H₂ stream and then quickly brought back to room temperature by opening the furnace. The catalysts were then purged with helium for half of an hour before passivation.

Thin Layer Electrode Depositions: A thin catalyst layer (preferably from about 10 μm to about 50 sum) was deposited on top of the various supports. This layer was deposited onto the support via applied pressure (using the specimen mount press), via aqueous deposition, and via the use of binders, including polyvinylacetate (PVA) and Norland Optical Adhesive (Norland Products, Inc., Cranbury, N.J.).

For aqueous deposition, a catalyst slurry was prepared using the powdered catalyst and filtered, de-ionized water. The slurry was pasted on top of the support in a uniform layer, as thin as possible, and the water removed through gentle heating using a hot plate. For catalysts bound with PVA, a layer of PVA dissolved in water was first coated over the entire support. The catalyst powder was then sprinkled over the top of the support and the resulting slurry uniformly coated as thin as possible.

The PVA-prepared electrodes were then heat-treated in flowing (100 cm³ (NTP)/min) helium. The helium stream was heated using a linear temperature ramp (4.6 K/min) for 1 hour to the final temperature of 573 K to facilitate the removal of excess PVA binder. The catalysts were held at this temperature for half an hour in the flowing helium stream and then quickly brought back to room temperature by opening the furnace.

Norland optical adhesive was also used as a binder in the same fashion as the PVA. The adhesive was spread on top of the catalyst support. The catalyst powder was the sprinkled over the top of the adhesive-coated support and the resulting slurry uniformly coated as thin as possible. The Norland optical adhesive was then stabilized by exposure to long wave ultraviolet light radiation and subsequently given a similar heat treatment as described above for the PVA-bound catalyst electrodes.

Synthesis of Gold Nanotube Membranes: Poreticsg track-etched polycarbonate membranes were used for all of the Examples. These membranes were 10 em-thick and contained pores of 220 nm-diameter with a pore density of about 3×10⁸ cm⁻². All chemicals used to prepare the membranes were used as received: anhydrous SnCl₂ (Alfa Aesar), CF₃COOH (Mallinckrodt, Phillipsburg, N.J.), AgNO₃ (Sigma-Aldrich, St. Louis, Mo.), anhydrous Na₂SO₃ (Mallinckrodt), HCHO (Fisher Scientific), and a gold solution, “Oromerse SO Part B-brand purchased from Technic Inc., Cranston, R.I.). Milli-Q water and methanol (Fisher Scientific) were used to prepare all solutions and to rinse the membranes.

Two polycarbonate membrane sheets (8×12 cm in size) were placed in polycarbonate holders and immersed for 50 min in 500 ml of a solution containing 0.026 M SnCl₂ and 0.070 M CF₃COOH with a 50/50 water/methanol as the solvent. The membranes were next immersed in methanol for 2.5 min, two consecutive times, followed by immersion in 300 ml of an aqueous ammoniacal AgNO₃ solution (0.029 M) for 5 min and subsequent immersion in methanol for 5 min. The ammoniacal silver solution was prepared freshly by adding a 0.88 M NH₄OH solution drop by drop to the AgNO₃ solution until the color of the solution became completely clear.

Electroless deposition of gold commenced when the Ag-treated membranes were placed in a bath containing 1,500 ml of a plating solution at a temperature of 276 K. The aqueous plating solution contained 0.127 M Na₂SO₃, 7.9×10⁻³ M gold in the chemical form Na₃Au(SO₃)₂, and 0.693 M HCHO. After about 15 min to about 2 h of electroless gold deposition, the membranes were rinsed in water and wiped gently with a methanol-soaked Kimwipes® EX-L tissue (Kimberly-Clark, Neenah, Wis.) to remove gold from the outer surfaces. The membranes were then rinsed with water three times and cleaned by immersion in 25% nitric acid for 15 h, followed by rinsing in water three times. Membranes were dried and stored in a vacuum desiccator.

Preparation of Polyoxometalates [PVₙMo₁₂₋ₙO₄₀] (n=1, 2, 4, or 6): Sodium phosphomolybdovanadate salts Naₙ₊₃[PVₙMo₁₂₋ₙO₄₀] (n=1, 2, 4, or 6) and partial salts of the formula of H₇₋ₘNaₘ[PV₄Mo₈O₄₀] (m=4, or 6) were prepared according to the method described in elsewhere (see U.S. Pat. No. 5,792,721). In a typical procedure for Na₄[PVMo₁₁O₄₀], 0.455 g of V₂O₅ (2.5×10⁻³ mol) was suspended in 100 cm³ of deionized water and heated to 333 K. Afterwards 0.265 g of Na₂CO₃ (2.5×10⁻³ mol) was added with vigorous stirring, resulted in a homogeneous, greenish solution accompanying CO₂ liberation and V₂O₅ dissolution to sodium metavanadate. After aging for 1 h at 333 K, 5 cm³ of 3 wt % H₂O₂ was added drop-wise to oxidize V⁴⁺ species, resulting in a color change to a clear orange. This mixture was held for 1 h at 333 K to decompose excess amounts of hydrogen peroxide. The mixture was then cooled to room temperature and vacuum-filtered using filter paper (Whatman No. 2). Into this clarified sodium metavanadate solution, 7.92 g of MoO₃ (5.5×10⁻² mol) was added at 333 K, followed by slow addition of 0.795 g of Na₂CO₃ (7.5×10⁻³ mol). Finally, 0.567 g of 85 wt % H₃PO₄ (5×10⁻³ mol) was added and held at 333 K for 3 h. The synthesized POM solution was evaporated at 353 K and vacuum dried to obtain POM powder. The syntheses of other POM salts containing sodium cations were carried out using the same method but the relative ratios of raw materials were varied.

The acid form of POMs Hₙ₊₃[PVₙMo₁₂₋ₙO₄₀] (n=1, 2, or 4) were synthesized using a method formerly described by Tsigdinos and Hallada (1968), Inorganic Chemistry, 7: 437. To make H₅[PV₂Mo₁₀O₄₀], for example, 20 cm³ of concentrated sulfuric acid was added slowly to a solution consisting of 7.1 g Na₂HPO₄ (5×10⁻² mol) in 100 cm³ deionized water and 12.2 g sodium metavanadate (0.1 mol) in 100 cm³ of boiling water. After a few drops had been added to the solution, the color turned to a dark red. To this solution, 121 g (0.5 mol) of Na₂MoO₄.2H₂O that had been dissolved in 200 cm³ water was added, followed by an additional drop-wise addition of sulfuric acid (85 cm³), resulting in a lighter red color. The POM acid was then extracted with 1 liter of pure diethyl ether. The middle layer (POM etherate layer) was separated and evaporated at 343 K to remove the ether. H₄[PVMo₁₁O₄₀] or H₇[PV₄Mo₈O₄₀] was synthesized similarly by varying the relative ratios of raw materials. The acid form POM H₅[PV₂Mo₁₀O₄₀] was also prepared from the sodium salt form Na₅[PV₂ Mo₁₀O₄₀] by using an ion exchange resin in the hydrogen form (Dowex 50-X8, Aldrich).

Reactive Ion Etching: Reactive ion etching (RIE) was used to expose gold nanotubes grown within the pores of track-etched polycarbonate. The gold membranes were mounted on a cover slip and placed on a plasma electrode inside the RIE system (Plasma Therm 1441 RIE at the Wisconsin Center for Applied Microelectronics, Madison, Wis.). The frequency of the RF generator was 13.56 MHz with a power of 100 W. After the RIE chamber was evacuated, O₂ gas was introduced at a flow rate of 15 cm³/min and the chamber pressure was maintained at 5×10⁻⁶ bar. The etch rate was 156 nm/min, and the etching time was varied to achieve the desired length of gold nanotubes to be exposed.

Formation of Self-Assembled Monolayers on Gold Nanotubes: Adsorption of thiols on membranes containing gold nanotubes was carried out to make a gold-based proton exchange membrane (PEM), using 3-mercapto-1,2-propanesulfonic acid, sodium salt (HS(CH₂)₃SO₃Na (Aldrich). The membrane containing the gold nanotubes was first treated in UV light for 10 min on each side and then immersed in ethanol for 20 min. The membrane was subsequently held for 15 h in 200 cm³ of thiol solution (2×10⁻³ M in a 50/50 solution of water/ethanol), followed by rinsing in 50/50 solution of water/ethanol, two times. The membranes were dried and stored in a vacuum desiccator.

Reaction Kinetics Studies: Reaction kinetics studies of CO oxidation with POM compounds over gold nanotube membranes were conducted using an apparatus consisting of three main sections: 1) the feed section, where the gas and liquid inlet compositions are fixed (not shown); 2) the membrane reactor, where the reaction takes place; and 3) the analysis section, where the products are quantified. The membrane reactor is illustrated in FIG. 1A.

In a typical experiment, the feed to the membrane reactor comprised a gaseous stream on one side of the membrane and a liquid stream on the other side. The composition of the gas stream was fixed by mixing the appropriate flow rates of carbon monoxide and N₂ at a total pressure of 1 bar. These gases were purified using Alltech-brand molecular sieve traps to remove traces of hydrocarbons and water. Further purification of carbon monoxide (e.g., elimination of iron carbonyls) was achieved by flowing this gas through a glass U-tube heated to 473 K. The total flow rate of gas feed to the membrane reactor was 50 cm³/min at the inlet 50 (FIG. 1A). All flow rates were fixed using mass flow controllers from Teledyne Hasting Instruments, Los Angeles, Calif. The liquid feed comprised pure water or an aqueous solution comprising a POM compound. Millipore water was used for the liquid feed and also for the preparation of all solutions. All liquids were continuously degassed by sparging with N₂ at 100 cm³/min. A typical flow rate of liquid to the membrane reactor was 1 cm³/min at the inlet 60, delivered using a polyetheretherketone (PEEK)-lined digital pump from LabAlliance, State College, Pa.

The reactor comprises gas chamber (102) and liquid chamber (104), as shown in FIG. 1A. The gold membrane (14) is placed between these chambers using a pair of membrane holders (12) containing arrays of ¼-inch holes. The chambers and the holders are preferably made of polycarbonate. In the reactor used in the Examples, each chamber had a volume of 40 cm³, and the gas or liquid streams were distributed at the bottom of the corresponding chamber using a channel with a row of evenly spaced holes (not shown). Each chamber has an o-ring in a groove to ensure that no leaks occur between the chambers and the membrane holders (not shown in FIG. 1A).

For studies of membranes that had been subjected to reactive ion etching, the etched side was positioned to face the gas stream (that is, toward chamber 102 in FIG. 1A). The area of a single membrane directly exposed to each reaction chamber was 96 cm². Prior to collecting reaction kinetics data, both chambers were purged with N₂ at 100 cm³/min for at least 1 h. The liquid chamber was then closed and N₂ was kept flowing through the gas chamber. Subsequently, the liquid feed was pumped into chamber 104 via inlet 60, and the outlet 62 was opened when the chamber was full with liquid. At this point, CO was fed to the chamber 102 (via inlet 50 in FIG. 1A).

All reactions presented in the Examples were conducted at room temperature (approximately 298 K). The gas and liquid streams flowed out from the reactor at the tops of the corresponding chambers through channels with evenly spaced holes (not shown) and exited the reaction chambers at outlets 52 and 62 in FIG. 1A. The transport of gas or liquid to the respective chambers can be controlled using back-pressure regulators (Tescom Corporation, Elk River, Minn.) at the effluent of each stream. Under the reaction conditions used in the Examples, the pressure gradient was kept below 0.35 bar to avoid the transport of gas to the liquid chamber, and the pressure gradient was maintained above 0.04 bar to prevent the flow of liquid to the gas chamber.

The feed and the products in the effluent gas streams were analyzed with a gas chromatograph (Hewlett Packard 5890) equipped with a thermal conductivity detector, a 30-foot Alltech column packed with 120/100-mesh Hayesep DB, and using nitrogen as a carrier. The column was initially kept at 313 K for 10 min, and the temperature was then ramped at 20 K min-1 to 513 K, where it was kept for 10 min. The temperature program allows the analysis of non-condensable gases and water vapor. For gaseous streams with low concentrations of non-condensable gases, further analyses were conducted with a Shimadzu GC-8A chromatograph equipped with a thermal conductivity detector and a 30-foot Alltech column packed with 120/100-mesh Hayesep DB. This gas chromatograph was operated isothermally at 323 K, and had a cold trap (at 193 K) at the inlet to condense water vapor, thus allowing for faster and cleaner analyses of the gas stream. Both gas chromatographs were calibrated using customized mixtures of H₂ in N₂, CO in N₂, and CO₂ in N₂ (formulated by Linde).

A batch reactor was used to measure the rate of CO oxidation on metal supported carbon catalysts suspended in aqueous POM solutions at 298 K. The batch reactor with 20 cm³ of 0.05 M POM solution and 0.1 g of 0.8 wt % Au/C catalyst was purged three times with CO and then filled with CO at a pressure of 15 bar. The reactor was a stainless steel vessel (approximately 350 cm³ volume), where the POM solution and catalyst were placed in a glass liner with a magnetic stirrer. The gas phase products were analyzed using an online gas chromatography (GC) at 10-min intervals by releasing the pressure. The GC (Hewlett Packard 5890) was equipped with a thermal conductivity detector (TCD), a 30-foot Alltech column packed with 120/100-mesh Hayesep DB, and used nitrogen as a carrier. The column was initially kept at 313 K for 10 min, and the temperature was then ramped at 20 K min⁻¹ to 513 K, where it was kept for 10 min. The temperature program allowed the analysis of non-condensable gases and water vapor.

Energy Storage: Two different reactor systems were employed to chemically reduce solutions of POM compounds at 298 K: a semi-batch type reactor and a pressurized batch reactor. The semi-batch reactor was first purged with 50 cm³/min of N₂ for at least 1 h, and then 50 cm³/min of CO was fed continuously at 1 bar through a fritted gas cylinder wrapped with a sheet of gold nanotube membrane, which was immersed in 250 cm³ of POM solution. The reactor was a three-neck glass vessel (500 cm³ volume) with a magnetic stirrer and a water-cooler condenser at the gas outlet. The gaseous product stream was analyzed using the on-line GC employed in reaction kinetics studies until no further CO₂ was produced.

The pressurized batch reactor was purged three times with CO and then filled with CO at a pressure of 15 bar. The reactor was a stainless steel vessel (approximately 350 cm³ volume), and it was filled with 30 to 100 cm³ of the POM solution placed in a glass liner with a magnetic stirrer in the presence of turnings of 1 sheet of gold nanotube membrane or Au/C catalysts. The gas phase products were analyzed using the same gas chromatograph for kinetics studies every 3 hours by releasing pressure, followed by pressurizing with CO at 15 bar again. This release of gas phase and pressurization of CO was repeated until no further CO₂ was produced.

Fuel Cell Studies: At least 7 types of fuel cells were employed to investigate the generation of electrical energy from reduced POM solutions produced by oxidation of CO on gold nanotubes. The following combinations of fuel cells were constructed and tested; each entry is designated by (anode)/(membrane)/(cathode):
1) (gold nanotubes)/(Nafiong-brand PEM)/(Pt/C),
2) (gold nanotubes)/(Nafiong-brand PEM)/(gold nanotubes),
3) (gold nanotubes)/(gold nanotubes functionalized with thiols)/(Pt/C),
4) (graphite on carbon paper)/(Nafion®-brand PEM)/(Pt/C),
5) (gold on carbon paper)/(Nafion®-brand PEM)/(Pt/C),
6) (platinum on carbon paper)/(Nafion®-brand PEM)/(Pt/C), and
7) (graphite on carbon paper)/(Nafion®-brand PEM)/(graphite on carbon paper).
   The gold anode and cathode (4×4 cm size) were fashioned from gold nanotube membranes (gold deposited for 2 h without removing the surface gold to improve electric conductivity), and the Nafion®-brand PEM membrane and Pt/C cathode were purchased from Aldrich (Nafion® 117, catalog no. 27467-4) and “h-tec” cathode (catalog no. 1996E), respectively. As a substitute for the Nafion®-brand membrane, a gold nanotube membrane that had been functionalized with a self-assembled monolayer of a sulfonic acid thiol, as outlined above, was also used. Carbon paper was used to make electrodes loaded with graphite (Carbone of America, Ultra F purity), Au/C (World Gold Council, Type D), or Pt/C (Aldrich, 20595-8). A slurry of the catalyst powder with an aqueous solution of polyvinyl alcohol (Aldrich, 34840-6) was pasted on one side of the carbon paper, to achieve metal loadings of 0.03 for gold and 0.4 mg cm⁻² for platinum. This carbon paper with catalytic layer was then heat-treated in a helium atmosphere at 573 K for 4 h. Anodes containing precious metals showed higher current densities by about 20% and about 50% at 200 mV and 100 mV, respectively, as compared to a simple graphite anode.

The Nafion®-brand or functionalized gold nanotube membrane was sandwiched between the anode and cathode electrodes, and this assembly was placed between a pair of stainless steel current collector screens. The volumes of the anode and cathode chambers were approximately 2 cm³. The reduced POM solution (blue color) was fed through the anode chamber at a flow rate 1 cm³/min. The cathode chamber was supplied with 10 cm³/min of O₂ for the Pt/C cathode, or it was supplied with oxidized POM solution (yellow or pinky-brown color for H₃PMo₁₂O₄₀ or Hₙ₊₃[PVₙMo₁₂₋ₙO₄₀], respectively) at a flow rate 1 cm³/min when a gold nanotube membrane or carbon was employed as the cathode. The color of POM solution changed reversibly between blue (reduced, 100) and yellow (oxidized, 98) for H₃PMo₁₂O₄₀, depending on the electron transfer. See FIGS. 1A, 1B, and IC. The current density was determined by measuring voltages generated by the fuel cell when it was loaded with a variable resistance of from about 9000 to about 0.01 Ω (1433-W Decade Resistor, General Radio USA).

For fuel cell studies using [PVₙMo₁₂₋ₙO₄₀]⁽³⁺ⁿ⁾⁻, two types of fuel cell systems were employed to investigate the generation of electrical energy from reduced POM solutions produced by oxidation of CO on gold nanoparticles: 1) reduced POM at the anode and O₂ at the cathode: and, 2) reduced POM at the anode and oxidized the POM at cathode. The anode electrode (4×4 cm size) was made of carbon paper (E-TEK, B-3/2050A-2050), which was “non wet-proof” and heat-treated at 873 K in air to increase hydrophilicity, onto which graphite (Carbone of America, Ultra F purity) was pasted on one side. In cases where O₂ was used as an oxidant, the cathode electrode was a Pt/C catalyst pasted on carbon paper supplied from h-tec (Item 1996E), and the aforementioned carbon electrode was used as the cathode when oxidized POM was fed as the oxidant to the cathode. A Nafion®-brand membrane (Nafion® 117, Aldrich) was sandwiched between the anode and cathode electrodes, followed by hot-pressing at 400 K for 4 h. After cooling to room temperature, this assembly was placed between a pair of stainless steel current collector screens. The volumes of the anode and cathode chambers were equal to approximately 2 cm³. The reduced POM solution (blue color) was fed through the anode chamber at a flow rate 1 cm³ min⁻¹. While the reduced [PMo₁₂O_{40]}³⁻ was stable in air with negligible reoxidation without catalysts, the reduced [PVₙMo₁₂O₄₀]⁽³⁺ⁿ⁾⁻ with n≧1 was readily reoxidized with air without the need for a catalyst; therefore, the reduced solution was removed from the batch reactor in a glove box to avoid air exposure. The cathode chamber was supplied with 10 cm³ min⁻¹ of O₂ for the Pt/C cathode, or it was supplied with oxidized POM solution at a flow rate 1 cm³ min⁻¹ when the carbon electrode was employed as the cathode. The color of POM solution changed reversibly between blue and the initial oxidized color, depending on the electron transfer. The current density was determined by measuring voltages generated by the fuel cell when it was loaded with a variable resistance from 9000 to 0.01 Ω (1433-W Decade Resistor, General Radio USA).

Results of CO Oxidation on Different Metal Catalysts with POM: A batch reactor was used to measure the rate of CO oxidation on different metals (supported carbon), such as Au, Pd, Pt, Ir, Rh, Ru, and Ag on C, by the aqueous POM solutions at 298 K. In each run, the batch reactor was charged with 20 cm³ of 0.05 M POM solution and 0.01 to 0.1 g of each catalyst. The batch reactor was then was purged three times with CO and then filled with CO at pressures of from 50 to 230 psia. The reactor was a stainless steel vessel (approximately 350 cm³ volume), with the POM solution and the catalyst placed in a glass liner with a magnetic stirrer.

The gas-phase products were analyzed using an online gas chromatography (GC) at 10 min by releasing pressure accumulated in the reactor. The GC used was a Hewlett Packard 5890 equipped with a thermal conductivity detector, a 30-foot Alltech column packed with 120/100-mesh Hayesep DB, and using nitrogen as a carrier. The column was initially kept at 313 K for 10 min, and the temperature was then ramped at 20 K min⁻¹ to 513 K, where it was kept for 10 min. The temperature program allowed non-condensable gases and water vapor to be analyzed.

The observed rates of CO oxidation are presented in Table. 1, together with descriptions of the catalysts used. All the experiments were performed under diffusion limitation-free conditions (i.e., at concentrations where less than 10% of the initial POM charged into the reactor was reduced). This was determined via a series of preliminary tests with various amounts of catalyst. At the higher pressures of CO (230 psia), the TOF showed greater values in the order of Pd>Au>Pt>Ir>Rh>Ru, and the Ag/C showed a negligible activity. The TOF at the lower pressure of 50 psia CO, the Au/C catalyst showed slightly better activity than the others.

TABLE 1
Results of CO Oxidation on Different Metal Catalysts with Mo₁₂-POM
at 298 K.

| | Metal | Metal | | | Rate at | |
|---|---|---|---|---|---|---|
| | loading | dispersion | Rate at 50 psia | | 230 psia | |
| Catalysts | (wt %) | (%)^{a} | Rate^{b} | TOF^{c} | Rate^{b} | TOF^{c} |
| Au/C | 0.8 | 12 | 56650 | 1.55 | 160810 | 4.4 |
| Pd/C | 1 | 23 | 183160 | 1.4 | 686840 | 5.25 |
| Pt/C | 1 | 39 | 144000 | 1.2 | 306000 | 2.55 |
| Ir/C | 1 | 13 | 17630 | 0.43 | 61510 | 1.5 |
| Rh/C | 1 | 18 | 7350 | 0.04 | 17840 | 0.17 |
| Ru/C | 1 | 55 | 3260 | 0.01 | 13060 | 0.04 |
| Ag/C | 1 | 9 | N.D.^{d} | 0 | N.D.^{d} | 0 |

^{a}The Au/C was estimated from the average particle sizes from TEM images and Ag/C was determined by O₂ chemisorption at 150° C. The other catalysts were determined from CO chemisorption at room temperature.
^{b}μmol of CO₂ production per gram of metal per minute.
^{c}Turnover frequency (s⁻¹).
^{d}Not detectable.

The data in Table 1 are significant because they demonstrate that CO can be selectively oxidized to CO₂ over various metal catalysts and using an oxidized POM and the oxidizing agent (liquid H₂O).

Preferential Oxidation (PROX) of CO in H₂ on Different Metal Catalysts with POM: In the same fashion as in the immediately preceding Example, a batch reactor was used to measure the rate of CO oxidation on different metal-containing catalysts supported on carbon, using the aqueous POM solutions at 298 K. The reaction conditions were the same as in the previous Example. The rate of H₂ oxidation was measured by monitoring the color change of the POM solution using a UV-visible spectrometer operating at 500 nm. The results are shown in Table 2.

It is observed that the rate of CO oxidation by the present invention is 10 times faster than the rate of H₂ oxidation when both gases are passed separately over a gold catalyst. Also, the rate of CO oxidation is at least an order of magnitude faster than the rate of H₂ oxidation when using a CO:H₂ gas mixture containing about 10% CO. These results indicate that the present invention can, in fact, be used to remove or deplete CO from H₂ gas streams without significantly consuming H₂. Thus, the resulting product gas (containing H₂) is suitable for a fuel in fuel cell applications.

TABLE 2
Results of Preferential Oxidation (PROX) of CO in H₂ on Different Metal Catalysts
with Mo₁₂-POM at 298 K.

| | | | Pressure | | | | |
|---|---|---|---|---|---|---|---|
| | Pressure | Pressure | 10% CO:H₂ | Rate of | TOF of | TOF of | |
| Catalysts | CO (psia) | H₂ (psia) | (psia) | CO₂^{a} | CO (s⁻¹) | H₂ (s⁻¹) | Ratio^{b} |
| Au/C | 215 | | | 162870 | 4.46 | | |
| | | 215 | | | | 0.48 | 9.3 |
| | 21.5 | 193.5 | 215 | 25600 | 0.70 | N.D.^{c} | — |
| | 3.5 | 31.5 | 35 | 3960 | 0.11 | N.D.^{c} | — |
| Pt/C | 215 | | | 239480 | 2.00 | | |
| | | 215 | | | | 7.42 | 0.27 |
| | 21.5 | 193.5 | 215 | 90840 | 0.76 | 0.39 | 1.92 |
| | 3.5 | 31.5 | 35 | 19210 | 0.16 | 0.15 | 1.03 |
| Pd/C | 215 | | | 654800 | 5.05 | | |
| | | 215 | | | | 1.13 | 4.48 |
| | 21.5 | 193.5 | 215 | 48500 | 0.37 | 0.20 | 1.86 |
| | 3.5 | 31.5 | 35 | 6390 | 0.05 | 0.08 | 0.61 |
| Ir/C | 215 | | | 56160 | 1.37 | | |
| | | 215 | | | | 0.35 | 3.96 |
| | 21.5 | 193.5 | 215 | 10370 | 0.25 | 0.09 | 2.81 |
| | 3.5 | 31.5 | 35 | 2300 | 0.06 | 0.05 | 1.19 |

^{a}μmol of CO₂ production per gram of metal per minute.
^{b}The rate ratio of TOF (CO) and TOF (H₂).
^{c}Not detectable.

Oxidation of CO with Various Transition Metal Compounds on Gold Nanotubes at 298 K: This Example was conducted as in the immediately preceding Example, with the exception that aqueous solutions of various transition metals (TMs) were fed, instead of flowing the POM solution, through the liquid chamber of membrane reactor where the gold membrane catalyst was loaded. The results are presented in Table 3:

TABLE 3
Oxidation of CO with Various Transition Metal Compounds on Gold
Nanotubes at 298 K^{a}

| Transition metals | CO₂ rate | | |
|---|---|---|---|
| (TM) | (μmol/gAu/min) | e⁻/TM by CO₂ | H⁺/TM by pH |
| Cu(NO₃)₂ | 6.0 | 1.14E+00 | 1.85E−01 |
| CuCl₂ | 0.5 | | |
| CuCl | 0.5 | | |
| Bis(ethylene | 1.5 | 2.85E−01 | basic |
| diamine)Cu(OH)₂ | | | |
| Co(NO₃)₂ | 4.4 | 8.36E−01 | 3.59E−04 |
| CuSO₄ | 2.5 | 4.75E−01 | 4.58E−02 |
| Fe(NO₃)₃ | 4.1 | 7.79E−01 | 8.91E−02 |
| FeCl₃ | 1.0 | 1.90E−01 | 6.96E−02 |
| KMnO₄ | 7.5 | — | pH increase |
| Ce(NO₃)₃ | 2.0 | 3.80E−01 | 2.32E−03 |
| Ni(NO₃)₂ | 2.4 | 4.56E−01 | 4.93E−04 |
| Zn(NO₃)₂ | 2.0 | 3.80E−01 | 2.67E−03 |

^{a}Concentration of TM solution = 0.01 M, liquid flow rate = 0.2 cm³/min, CO flow rate = 12 cm³/min.

The data presented in Table 3 are significant because they show that CO can be selectively oxidized to CO₂ over a gold catalyst combined with a host of different transition metals.

Oxidation of CO with H₃PMo₁₂O₄₀ on Au/C (World Gold Council) at 298 K and 230 psia of CO Pressure: Here, the reaction was carried out as recited in the prior examples, and 10 the catalyst was a gold on carbon catalyst purchased from the World Gold Council. The results are presented in Tables 4 and 5:

TABLE 4
Oxidation of CO with Mo₁₂-Polyoxometalate on Au/C (WGC) at 298 K
and 230 psia of CO Pressure^{a}

| | CO₂ produced for | | Turnover |
|---|---|---|---|
| Weight of | initial 10 min | Rate of CO₂ | frequency |
| 0.8 wt % Au/C (g) | (μmol) | (μmol/gAu/min) | (TOF, s⁻¹)^{b} |
| 0.50 | 902 | 37575 | 1.03 |
| 0.10 | 585 | 121795 | 3.33 |
| 0.05 | 346 | 143995 | 3.93 |
| 0.03 | 248 | 171993 | 4.70 |
| 0.01 | 81 | 167993 | 4.60 |
| Carbon alone^{c}, 0.5 g | 29 | | |
| Blank | 17 | | |

^{a}In a pressurized batch reactor with 20 cm³ of 0.05 M Mo-POM solution on a reference gold catalyst (World Gold Council, Sample 4D).
^{b}The values were based on the gold dispersion of 12% (i.e., 7-10 nm size of average particle sizes of gold).
^{c}Black Pearls 2000 carbon black (Cabot Corp., GP-3821).

TABLE 5
Oxidation of CO with Mo₁₂-Polyoxometalate on Au/C (WGC) at 298 K^{a}

| | CO₂ produced for | | |
|---|---|---|---|
| CO pressure | initial 10 min | Rate of CO₂ | Turnover frequency |
| (psia) | (μmol) | (μmol/gAu/min) | (TOF, s⁻¹)^{b} |
| 730 | 585 | 406245 | 11.1 |
| 450 | 411 | 285641 | 7.81 |
| 230 | 248 | 171993 | 4.70 |
| 100 | 119 | 82638 | 2.26 |
| 50 | 73 | 50695 | 1.38 |

^{a}In a pressurized batch reactor with 20 cm³ of 0.05 M Mo-POM solution on 0.03 g of a reference gold catalyst (WGC, Sample 4D).
^{b}The value were based on the gold dispersion of 12% (i.e., 7-10 nm size of average particle sizes of gold).

The data presented in Tables 4 and 5 are significant because they show that this gold catalyst is capable of selectively oxidizing CO using the POM as an oxidizing agent.

Storage of Energy by Oxidation of CO with POMs on Gold Nanotubes and Generation of Electrical Energy from Fuel Cell at 298 K: Here, various solutions of reduced POM where generated in a batch or semi-batch reactor as described previously and subsequently used as a fuel to power a fuel cell at 298K. The results are shown in Table 6.

TABLE 6
Storage of Energy by Oxidation of CO with Several Polyoxometalates on Gold
Nanotubes and Generation of Electrical Energy from Fuel Cells at 298 K

| | | | | Hydrogen-storage solution | | | |
|---|---|---|---|---|---|---|---|
| | CO oxidation | | | Total | | | |
| | Molarity | Pco | | CO₂ | e⁻/ | e⁻/ | Reduced |
| Polyoxometalate | (M) | (bar) | Reactor | (μmol)^{a} | Keggin^{b} | Keggin^{c} | solution |
| H₃PMo₁₂O₄₀ | 0.01 | 1 | semi- | 4400 | 3.60 | | |
| | | | batch | | | | |
| | 0.05 | 1 | semi- | 21000 | 3.52 | 3.00 | Blue I |
| | | | batch | | | | |
| | 0.1 | 15 | batch | 16300 | 3.26 | 4.95 | Blue II |
| | 0.5 | 15 | batch | 122000 | 4.89 | 4.25 | Blue III |
| | 1.0^{d} | 15 | batch | 122300 | 4.45 | 4.10 | Blue IV |
| H₃PW₁₂O₄₀ | 0.01 | 1 | semi- | 250 | 0.20 | | |
| | | | batch | | | | |
| H₅[PV₂Mo₁₀O₄₀] | 0.2 | 15 | batch^{e} | 20200 | 6.73 | | |
| H₇[PV₄Mo₈O₄₀] | 0.2 | 15 | batch^{e} | 21100 | 7.04 | | |
| Na₇[PV₄Mo₈O₄₀] | 0.2 | 15 | batch^{e} | 19300 | 6.44 | | |

^{a}Total amount of CO₂ produced in gas phase and measured by GC.
^{b}Number of electrons stored per Keggin unit, measured by the amount of CO₂ production.
^{c}Number of electrons stored per Keggin unit, calculated by integrating the electric current (in amperes).
^{d}CO-pressurized batch reaction with liquid amount of 55 cm³.
^{e}Liquid amount of 30 cm³ with 0.1 to 0.2 g of Au/C catalysts.

The various reduced solutions of H₃PMo₁₂O₄₀ were given Roman numeral designations (I-IV). As can be seen from Table 7 below, these fuels generated a significant amount of stored electrons per Keggin unit. This is significant because the stored electrons are a measure of the amount of energy that can be generated from the solutions when re-oxidized in a fuel cell.

Voltage Versus Current Density for a Single Fuel Cell at 298 K Using Au Nanotube Membrane (AuNT) Anodes, Gold-on-Carbon and Platinum-on-Carbon Anodes, and Carbon Anodes: Here, fuel cells were operated using the various POM solutions identified in Table 6, in fuel cells having various different anode compositions and configurations. The voltage vs. current density results for gold nanotube membrane anodes are shown in Table 7. The corresponding data for various gold and platinum anodes supported on carbon are shown in Table 8. The corresponding data for carbon anodes are shown in Table 9.

TABLE 7
Voltage versus Current Density for a Single Fuel Cell at 298 K
Using Au Nanotube Membrane (AuNT) anodes

| | | | | | | | Voltage vs. | | |
|---|---|---|---|---|---|---|---|---|---|
| | | Anode^{a} | | | Cathode^{b} | | Current density | | |
| | | | Metal | | | Metal | | | Max. |
| Solution | | AuNT | (mg/ | | | (mg/ | | | Power |
| run # | Blue | (h, nm)^{c} | cm²) | PEM | | cm²) | mV | mA/cm² | (mW) |
| 1 | II | 2, 220 | 2 | Nafion ® | Pt/C | 0.3 | 350 | open | 3.6 |
| | | | | 117 | | | 200 | 1.0 | |
| | | | | | | | 40 | 2.0 | |
| 2 | Cu | 2, 220 | 2 | Nafion ® | Pt/C | 0.3 | 281 | open | 0.5 |
| | red. | | | 117 | | | 200 | 0.12 | |
| | 0.5M | | | | | | 40 | 0.27 | |
| 3 | III | 2, 220 | 2 | AuNT | Pt/C | 0.3 | 270 | open | 7.3 |
| | | | | 2, 220 | | | 200 | 0.12 | |
| | | | | -thiol | | | 40 | 4.8 | |
| 4 | III | 2, 220 | 2 | AuNT | Pt/C | 0.3 | 260 | open | 4.2 |
| | | | | 0.5, 50 | | | 200 | 0.25 | |
| | | | | -thiol | | | 40 | 4.2 | |
| 5 | III | 2, 220 | 2 | AuNT | AuNT | 2 | 156 | open | 1.3 |
| | | | | 2, 220 | 2, 220 | | 200 | — | |
| | | | | -thiol | | | 40 | 2.0 | |

^{a}The liquid flow rate at anode = 1 cm³/min.
^{b}The flow rate at cathode was 10 cm³/min of O₂ when platinum-based cathode was used and 1 cm³/min of the oxidized polyoxometalate with same concentration as anode side when carbon- or gold-based cathode was employed.
^{c}Gold nanotube membranes with description of (gold deposition time in h, pore diameter in nm).

TABLE 8
Voltage versus Current Density for a Single Fuel Cell at 298 K
Using Gold- or Pt-Supported Anodes

| | | | | | | | Voltage vs. | | |
|---|---|---|---|---|---|---|---|---|---|
| | | Anode^{a} | | | Cathode^{b} | | Current density | | |
| | | | Metal | | | Metal | | | Max. |
| Solution | | | (mg/ | | | (mg/ | | | Power |
| run # | Blue | | cm²) | PEM | | cm²) | mV | mA/cm² | (mW) |
| 6 | III | Au/C | 1 | Nafion ® | Pt/C | 0.3 | 270 | open | 10.1 |
| | | on | | 117 | | | 200 | 2.1 | |
| | | C cloth^{c} | | | | | 40 | 6.5 | |
| 7 | III | Au/C | 0.05 | Nafion ® | Pt/C | 0.3 | 280 | open | 4.0 |
| | | on | | 117 | | | 200 | 0.65 | |
| | | C cloth | | | | | 40 | 3.6 | |
| 8 | III | Au/C | 0.05 | Nafion ® | Au/C | 0.05 | 276 | open | 4.0 |
| | | on | | 117 | on | | 200 | 1.0 | |
| | | C cloth | | | C cloth | | 40 | 2.6 | |
| 9 | III | Pt/BP^{d} | 1 | Nafion ® | Pt/C | 0.3 | 370 | open | 10.0 |
| | | on | | 117 | | | 200 | 2.0 | |
| | | B3 | | | | | 40 | 9.2 | |
| | | paper^{e} | | | | | | | |
| 10 | III | Pt/ | 1 | Nafion ® | Pt/C | 0.3 | 360 | open | 9.6 |
| | | Graphite | | 117 | | | 200 | 2.0 | |
| | | on | | | | | 40 | 10.2 | |
| | | B3 paper | | | | | | | |
| 11 | III | Au/C^{f} | 0.03 | Nafion ® | Pt/C | 0.3 | 351 | open | 13.7 |
| | | on | | 117 | | | 200 | 3.0 | |
| | | B3 paper | | | | | 40 | 11.5 | |
| 12 | III | Pt/C^{g} | 0.4 | Nafion ® | Pt/C | 0.3 | 360 | open | 15.8 |
| | | on | | 117 | | | 200 | 2.9 | |
| | | B3 paper | | | | | 40 | 16.0 | |

^{a}The liquid flow rate at anode = 1 cm³/min.
^{b}The flow rate at cathode was 10 cm³/min of O₂ when platinum-based cathode was used and 1 cm³/min of the oxidized polyoxometalate with same concentration as anode side when carbon- or gold-based cathode was employed.
^{c}Activated carbon fibers (ACF) in the form of a woven fabric (KoTHmex, AW1104).
^{d}Black Pearls 2000 carbon black (Cabot Corp., GP-3821).
^{e}Spectracorp carbon paper (E-Tek, B-3/2050A-2050).
^{f}0.8 wt % Au/C (World Gold Council, Type D).
^{g}10 wt % Pt/C (Aldrich).

TABLE 9
Voltage versus Current Density for a Single Fuel Cell at 298 K
Using Carbon Anodes

| | | | | | | Voltage vs. | | |
|---|---|---|---|---|---|---|---|---|
| | | | | Cathode^{b} | | Current density | | |
| | | | | | Metal | | | Max. |
| Solution | | | | | (mg/ | | mA/ | Power |
| run# | Blue | Anode^{a} | PEM | | cm²) | mV | cm² | (mW) |
| 13 | III | C cloth | Nafion ® | C | | 274 | open | 3.3 |
| | | | 117 | cloth | | 200 | 0.85 | |
| | | | | | | 40 | 2.3 | |
| 14 | III | C cloth | Nafion ® | Pt/C | 0.3 | 303 | open | 3.3 |
| | | | 117 | | | 200 | 0.80 | |
| | | | | | | 40 | 2.8 | |
| 15 | III | Graph- | Nafion ® | Pt/C | 0.3 | 314 | open | 16.1 |
| | | ite | 117 | | | 200 | 3.2 | |
| | | on | | | | 40 | 17.5 | |
| | | C cloth | | | | | | |
| 16 | III | Graph- | Nafion ® | Pt/C | 0.3 | 330 | open | 14.4 |
| | | ite | 117 | | | 200 | 3.0 | |
| | | on | | | | 40 | 16.0 | |
| | | B1 | | | | | | |
| | | Cloth^{c} | | | | | | |

^{a}The liquid flow rate at anode = 1 cm³/min.
^{b}The flow rate at cathode was 10 cm³/min of O₂ when platinum-based cathode was used and 1 cm³/min of the oxidized polyoxometalate with same concentration as anode side when carbon- or gold-based cathode was employed.
^{c}Carbon cloth in a plain weave (E-Tek, B-1/A).

### REFERENCES

1. J. R. Rostrup-Nielsen, T. Rostrup-Nielsen, CATTECH 6, 150(2002).
2. R. D. Cortright, R. R. Davda, J. A. Dumesic, Nature 418, 964 (2002).
3. G. W. Huber, J. W. Shabaker, J. A. Dumesic, Science 300, 2075 (2003).
4. G. A. Deluga, J. R. Salge, L. D. Schmidt, X. E. Verykios, Science 303, 993 (2004).
5. D. Wang, S. Czemik, E. Chomet, Energy & Fuels 12, 19 (1998).
6. Q. Fu, H. Saltsburg, M. Flytzani-Stephanopoulos, Science 301, 935 (2003).
7. N. A. Koryabkina, A. A. Phatak, W. F. Ruettinger, R. J. Farrauto, F. H. Ribeiro, J Catal. 217, 233 (2003).
8. X. Wang, R. J. Gorte, J. P. Wagner, J. Catal. 212, 225 (2002).
9. C. V. Ovesen, et al., J. Catal. 158, 170 (1996).
10. B. C. H. Steele, A. Heinzel, Nature 414, 345 (2001).
11. M. Haruta, T. Kobayashi, H. Sano, N. Yamada, Chem. Lett. 2, 405 (1987).
12. M. Valden, X. Lai, D. W. Goodman, Science 281, 1647 (1998).
13. G. C. Bond, D. T. Thompson, Gold Bull. 33, 41 (2000).
14. M. A. Sanchez-Castillo, C. Couto, W. B. Kim, J. A. Dumesic, Angew. Chem. Int. Ed 43, 1140 (2004).
15. S. K. Desai, M. Neurock, Phys. Rev. B 68, 075420 (2003).
16. R. R. Davda, J. A. Dumesic, Angew. Chem. Int. Ed 42, 4068 (2003).
17. M. Daté, M. Okumura, S. Tsubota, M. Haruta, Angew. Chem. Int. Ed. 43, 2129 (2004).
18. H. H. Kung, M. C. Kung, C. K. Costello, J. Catal. 216, 425 (2003).
19. G. M. Brown, M.-R. Noe-Spirlet, W. R. Busing, H. A. Levy, Acta Cryst. B33, 1038 (1977).
20. P. Gomez-Romero, N. Casaji-Pastor, J. Phys. Chem. 100, 12448 (1996).
21. See FIGS. 4A, 4B, and 4C.
22. S. Yu, N. Li, J. Wharton, C. R. Martin, Nano Lett. 3, 815 (2003).
23. H. Sakurai, A. Ueda, T. Kobayashi, M. Haruta, Chem. Commun., 271 (1997).
24. M. M. Schubert, A. Venugopal, M. J. Kahlich, V. Plzak, R. J. Behm, J. Catal. 222, 32 (2004).
25. L. E. Braind, G. T. Baronetti, H. J. Thomas, Appl. Catal. A 256, 37 (2003).

What is claimed is:

1. A method to produce energy from carbon monoxide, the method comprising:
(a) reacting a gas comprising carbon monoxide with a solution comprising an oxidized polyoxometalate (POM) in the presence of a metal-containing catalyst under conditions and for a time sufficient to reduce the POM to a reduced POM and to oxidize the carbon monoxide to carbon dioxide; and
(b) oxidizing the reduced POM in a fuel cell to generate energy.

2. The method of claim 1, wherein in step (a) a gas comprising carbon monoxide and hydrogen is reacted with the solution of oxidized POM, and wherein the oxidation of carbon monoxide to carbon dioxide yields a product gas comprising hydrogen and a depleted amount of carbon monoxide.

3. The method of claim 2, further comprising oxidizing the product gas in a fuel cell to generate energy.

4. The method of claim 1, wherein in step (a), the carbon monoxide is reacted with an aqueous solution comprising an oxidized POM.

5. The method of claim 1, wherein in step (a) the carbon monoxide is reacted with an aqueous solution comprising an oxidized POM that has a Keggin structure.

6. The method of claim 1, wherein in step (a) the carbon monoxide is reacted with an aqueous solution comprising an oxidized POM of formula I or II:
[Y₃₋₁₈]ⁿ⁺[X₁₋₄M₁₋₃₆O₁₀₋₆₀]ⁿ⁻ (I)
[Y₃₋₁₈]ⁿ⁺[M₁₋₃₆O₁₀₋₆₀]ⁿ⁻ (II)
wherein each “X” is independently selected from the group consisting of any element or molecular moiety having four or less atoms, each “M” is independently selected from the group consisting of metals, “Y” is a counter-cation, and “n” is an integer, acid forms thereof, salt forms thereof, and partial-salt forms thereof

7. The method of claim 1, wherein in step (a) the carbon monoxide is reacted with an aqueous solution comprising an oxidized POM of formula I or II:
[Y₃₋₁₈]ⁿ⁺[X₁₋₄M₁₋₃₆O₁₀₋₆₀]ⁿ⁻ (I)
[Y₃₋₁₈]ⁿ⁺[M₁₋₃₆O_{10-60]}ⁿ⁻ (II)
wherein each “X” is independently selected from the group consisting of P, Si, As, Ge, B, Co, S, and Fe; each “M”is independently selected from the group consisting of Mo, W, V, Ti, Co, Cu, Zn, Fe, Ni, Cr, lanthanides, Ce, Al, Ga, In, and Ti; each “Y” is a counter-cation selected from the group consisting of H, Zn, Co, Cu, Bi, Na, Li, K, Rb, Cs, Ba, Mg, Sr, ammonium, C₁₋₁₂-alkylammonium, and C₁₋₁₂-alkylamine; and “n” is an integer, acid forms thereof, salt forms thereof, and partial-salt forms thereof.

8. The method of claim 1, wherein in step (a) the carbon monoxide is reacted with an aqueous solution comprising an oxidized POM of formula (III):
[Y_{y}]ⁿ⁺[XM₁₂O₄₀]ⁿ⁻ (III)
wherein “X” is selected from the group consisting of Si, P, and Ge; each “M” is independently selected from the group consisting of Mo, W, and V; each “Y” is a counter-cation independently selected from the group consisting of H, Zn, Co, Cu, Bi, Na, Li, K, Rb, Cs, Ba, Mg, Sr, ammonium, C₁₋₁₂-alkylammonium, and C₁₋₁₂-alkylamine, and combinations thereof, and “n” and “y” are integers, acid forms thereof, salt forms thereof, and partial-salt forms thereof.

9. The method of claim 1, wherein in step (a) the carbon monoxide is reacted with an aqueous solution comprising oxidized H₃PMo₁₂O₄₀.

10. The method of claim 1, wherein in step (a), the carbon monoxide is reacted with the oxidized POM in the presence of a metal-containing catalyst selected from the group consisting of transition metal-containing catalysts and inner transition metal-containing catalysts.

11. The method of claim 1, wherein in step (a), the carbon monoxide is reacted with the oxidized POM in the presence of a metal-containing catalyst selected from the group consisting of Group VIIEB metal-containing catalysts and Group IB metal-containing catalysts.

12. The method of claim 1, wherein in step (a), the carbon monoxide is reacted with the oxidized POM in the presence of a metal-containing catalyst selected from the group consisting of noble metal-containing catalysts

13. The method of claim 1, wherein in step (a), the carbon monoxide is reacted with the oxidized POM in the presence of a gold-containing catalyst.

14. The method of claim 1, wherein in step (a), the carbon monoxide is reacted with the oxidized POM in the presence of a metal-containing catalyst wherein the metal-containing catalyst is a nanotube, a nanoparticle, or a combination thereof.

15. The method of claim 1, wherein in step (a), the carbon monoxide is reacted with the oxidized POM in the presence of a gold-containing catalyst wherein the gold-containing catalyst is a nanotube, a nanoparticle, or a combination thereof.

16. The method of claim 1, wherein in step (a) the carbon monoxide is reacted with the oxidized POM in the presence of a metal-containing catalyst immobilized on a substrate.

17. The method of claim 16, wherein the metal-containing catalyst is immobilized on a porous substrate, and wherein a portion of the metal-containing catalyst is immobilized within pores of the substrate.

18. The method of claim 17, wherein the metal-containing catalyst is immobilized on a track-etched polycarbonate template.

19. The method of claim 17, further comprising selectively etching the porous substrate to expose metal-containing catalyst disposed within the pores of the substrate.

20. The method of claim 1, wherein in step (a) the carbon monoxide is reacted with the oxidized POM at a temperature not greater than 300K.

21. A method to produce energy from carbon monoxide, the method comprising:
(a) reacting a gas comprising carbon monoxide with a solution comprising an oxidized polyoxometalate (POM) in the presence of a metal-containing catalyst, wherein the metal-containing catalyst is selected from the group consisting of Group VIIHB metal-containing catalysts and Group IB metal-containing catalysts, under conditions and for a time sufficient to reduce the POM to a reduced POM and to oxidize the carbon monoxide to carbon dioxide; and
(b) oxidizing the reduced POM in a fuel cell to generate energy.

22. The method of claim 21, wherein in step (a), the carbon monoxide is reacted with the oxidized POM in the presence of a gold-containing catalyst.

23. The method of claim 21, wherein in step (a), the carbon monoxide is reacted with the oxidized POM in the presence of a metal-containing catalyst wherein the metal-containing catalyst is a nanotube, a nanoparticle, or a combination thereof.

24. The method of claim 21, wherein in step (a), the carbon monoxide is reacted with the oxidized POM in the presence of a gold-containing catalyst wherein the gold-containing catalyst is a nanotube, a nanoparticle, or a combination thereof.

25. The method of claim 21, wherein in step (a) the carbon monoxide is reacted with the oxidized POM in the presence of a metal-containing catalyst immobilized on a substrate.

26. The method of claim 21, wherein the metal-containing catalyst is immobilized on a porous substrate, and wherein a portion of the metal-containing catalyst is immobilized within pores of the substrate.

27. The method of claim 26, wherein the metal-containing catalyst is immobilized on a track-etched polycarbonate substrate.

28. The method of claim 26, further comprising selectively etching the porous substrate to expose metal-containing catalyst disposed within the pores of the substrate.

29. The method of claim 21, wherein in step (a) the carbon monoxide is reacted with the oxidized POM at a temperature not greater than 300 K.

30. A method to deplete carbon monoxide from a stream of gas, the method comprising: reacting an incoming gas comprising carbon monoxide with a solution comprising an oxidized polyoxometalate (POM) in the presence of a metal-containing catalyst under conditions and for a time sufficient to reduce the POM and to oxidize the carbon monoxide to carbon dioxide, thereby depleting carbon monoxide from the stream of gas.

31. The method of claim 30, wherein the incoming gas comprises carbon monoxide and hydrogen, and wherein the oxidation of carbon monoxide to carbon dioxide yields a product gas comprising hydrogen and a depleted amount of carbon monoxide as compared to the incoming gas.

32. The method of claim 30, wherein the incoming gas is reacted with a aqueous solution comprising the oxidized POM.

33. The method of claim 30, wherein the incoming gas is reacted with an aqueous solution comprising an oxidized POM that has a Keggin structure.

34. The method of claim 30, wherein the incoming gas is reacted with an aqueous solution comprising an oxidized POM of formula I or II:
[Y₃₋₁₈]ⁿ⁺[X₁₋₄M₁₋₃₆O₁₀₋₆₀]ⁿ⁻ (I)
[Y₃₋₁₈]ⁿ⁺[M₁₋₃₆O₁₀₋₆₀]ⁿ⁻ (II)
wherein each “X” is independently selected from the group consisting of any element or molecular moiety having four or less atoms, each “M” is independently selected from the group consisting of metals, “Y” is a counter-cation, and “n” is an integer, acid forms thereof, salt forms thereof, and partial-salt forms thereof.

35. The method of claim 30, wherein the incoming gas is reacted with an aqueous solution comprising an oxidized POM of formula I or II:
[Y₃₋₁₈]ⁿ⁺[X₁₋₄M₁₋₃₆O₁₀₋₆₀]ⁿ⁻ (I)
[Y₃₋₁₈]ⁿ⁺[M₁₋₃₆O₁₀₋₆₀]ⁿ⁻ (II)
wherein each “X” is independently selected from the group consisting of P, Si, As, Ge, B, Co, S, and Fe; each “M,” is independently selected from the group consisting of Mo, W, V, Ti, Co, Cu, Zn, Fe, Ni, Cr, lanthanides, Ce, Al, Ga, In, and Tl; each “Y” is a counter-cation selected from the group consisting of H, Zn, Co, Cu, Bi, Na, Li, K, Rb, Cs, Ba, Mg, Sr, ammonium, C₁₋₁₂-alkylammonium, and C₁₋₁₂-alkylamine; and “n” is an integer, acid forms thereof, salt forms thereof, and partial-salt forms thereof.

36. The method of claim 30, wherein the incoming gas is reacted with an aqueous solution comprising an oxidized POM of formula (III):
[Y]ⁿ⁺[XM₁₂O₄₀]ⁿ⁻ (III)
wherein “X” is selected from the group consisting of Si, P, and Ge; each “M,” is independently selected from the group consisting of Mo, W, and V; each “Y” is a counter-cation independently selected from the group consisting of H, Zn, Co, Cu, Bi, Na, Li, K, Rb, Cs, Ba, Mg, Sr, ammonium, C₁₋₁₂-alkylammonium, and C₁₋₁₂-alkylamine, and combinations thereof, and “n” and “y” are integers, acid forms thereof, salt forms thereof, and partial-salt forms thereof.

37. The method of claim 30, wherein the incoming gas is reacted with an aqueous solution comprising oxidized H₃PMo₁₂O₄₀.

38. The method of claim 30, wherein the incoming gas is reacted with the oxidized POM in the presence of a metal-containing catalyst selected from the group consisting of transition metal-containing catalysts and inner transition metal-containing catalysts.

39. The method of claim 30, wherein the incoming gas is reacted with the oxidized POM in the presence of a metal-containing catalyst selected from the group consisting of Group VIIIB metal-containing catalysts and Group IB metal-containing catalysts.

40. The method of claim 30, wherein the incoming gas is reacted with the oxidized POM in the presence of a metal-containing catalyst selected from the group consisting of noble metal-containing catalysts.

41. The method of claim 30, wherein the incoming gas is reacted with the oxidized POM in the presence of a gold-containing catalyst.

42. The method of claim 30, wherein the incoming gas is reacted with the oxidized POM in the presence of a metal-containing catalyst wherein the metal-containing catalyst is a nanotube, a nanoparticle, or a combination thereof.

43. The method of claim 30, wherein the incoming gas is reacted with the oxidized POM in the presence of a gold-containing catalyst wherein the gold-containing catalyst is a nanotube, a nanoparticle, or a combination thereof.

44. The method of claim 30, wherein the incoming gas is reacted with the oxidized POM in the presence of a metal-containing catalyst immobilized on a substrate.

45. The method of claim 44, wherein the metal-containing catalyst is immobilized on a porous substrate, and wherein a portion of the metal-containing catalyst is immobilized within pores of the substrate.

46. The method of claim 44, wherein the metal-containing catalyst is immobilized on a track-etched polycarbonate substrate.

47. The method of claim 44, further comprising selectively etching the porous substrate to expose metal-containing catalyst disposed within the pores of the substrate.

48. A reactor to remove carbon monoxide from a stream of gas, the reactor comprising:
a first reaction chamber having an inlet and an outlet, wherein the inlet is dimensioned and configured to introduce a reactant gas comprising carbon monoxide into the first reaction chamber, and the outlet is dimensioned and configured to vent a product gas depleted of carbon monoxide from the first reaction chamber;
a second reaction chamber having an inlet and an outlet, wherein the inlet is dimensioned and configured to introduce an oxidized condensed liquid reactant into the second reaction chamber, and the outlet is dimensioned and configured to vent a reduced condensed liquid product from the second reaction chamber;
a membrane disposed between the first reaction chamber and the second reaction chamber, wherein the membrane is in contact with both the first and second reaction chambers and separates the first reaction chamber from the second reaction chamber;
a metal-containing catalyst disposed on the membrane, wherein the metal-containing catalyst is dimensioned and configured to catalyze a coupled oxidation-reduction reaction wherein within the first reaction chamber carbon monoxide present in the reactant gas is selectively oxidized to yield the product gas depleted of carbon monoxide, and within the second reaction chamber the oxidized condensed liquid reactant is reduced to yield the reduced condensed liquid product.

49. The reactor of claim 48, wherein the metal-containing catalyst is selected from the group consisting of transition metal-containing catalysts and inner transition metal-containing catalysts.

50. The reactor of claim 48, wherein the metal-containing catalyst is selected from the group consisting of Group VIIIB metal-containing catalysts and Group IB metal-containing catalysts.

51. The reactor of claim 48, wherein the metal-containing catalyst is selected from the group consisting of noble metal-containing catalysts.

52. The reactor of claim 48, wherein the metal-containing catalyst comprises a gold-containing catalyst.

53. The reactor of claim 48, wherein the metal-containing catalyst comprises metallic nanotubes, metallic nanoparticles, and combinations thereof.

54. The reactor of claim 48, wherein the metal-containing catalyst comprises a gold-containing catalyst and wherein the catalyst comprises gold nanotubes, gold nanoparticles, and combinations thereof.

55. The reactor of claim 48, wherein the electron-permeable membrane is porous, and wherein a portion of the metal-containing catalyst is disposed within pores of the substrate.

56. The reactor of claim 48, wherein the electron-permeable membrane comprises track-etched polycarbonate.

57. The reactor of claim 48, wherein the electron-permeable membrane comprises a porous substrate that has been selectively etched to expose metal-containing catalyst disposed within the pores of the substrate.

58. A device to generate electricity, the device comprising:
a reactor to remove carbon monoxide from a stream of gas; and
a fuel cell operationally connected to the reactor;
wherein the fuel cell comprises an anode disposed within an anode chamber, a cathode disposed within a cathode chamber, and a proton-exchange membrane disposed between the anode chamber and the cathode chamber, and
wherein the reactor comprises:
a first reaction chamber having an inlet and an outlet, wherein the inlet is dimensioned and configured to introduce a reactant gas comprising carbon monoxide into the first reaction chamber, and the outlet is dimensioned and configured to vent a product gas depleted of carbon monoxide from the first reaction chamber;
a second reaction chamber having an inlet and an outlet, wherein the inlet is dimensioned and configured to introduce an oxidized condensed liquid reactant into the second reaction chamber, and the outlet is dimensioned and configured to vent a reduced condensed liquid product from the second reaction chamber;
an electron-permeable membrane disposed between the first reaction chamber and the second reaction chamber, wherein the electron-permeable membrane is in contact with both the first and second reaction chambers and separates the first reaction chamber from the second reaction chamber; and
a metal-containing catalyst disposed on the membrane, wherein the metal-containing catalyst is dimensioned and configured to catalyze a coupled oxidation-reduction reaction wherein within the first reaction chamber carbon monoxide present in the reactant gas is selectively oxidized to yield the product gas depleted of carbon monoxide, and within the second reaction chamber the oxidized condensed liquid reactant is reduced to yield the reduced condensed liquid product;
and further comprising conduit operationally connecting the outlet of the second reaction chamber to the anode chamber of the fuel cell, wherein the conduit is dimensioned and configured to transfer the reduced condensed liquid product from the second reaction chamber of the reactor to the anode chamber of the fuel cell.

59. The device of claim 58, wherein the metal-containing catalyst is selected from the group consisting of transition metal-containing catalysts and inner transition metal-containing catalysts.

60. The device of claim 58, wherein the metal-containing catalyst is selected from the group consisting of Group VIIIB metal-containing catalysts and Group IB metal-containing catalysts.

61. The device of claim 58, wherein the metal-containing catalyst is selected from the group consisting of noble metal-containing catalysts.

62. The device of claim 58, wherein the metal-containing catalyst comprises a gold-containing catalyst.

63. The device of claim 58, wherein the metal-containing catalyst comprises metallic nanotubes, metallic nanoparticles, and combinations thereof.

64. The device of claim 58, wherein the metal-containing catalyst comprises a gold-containing catalyst and wherein the catalyst comprises gold nanotubes, gold nanoparticles, and combinations thereof.

65. The device of claim 58, wherein the electron-permeable membrane is porous, and wherein a portion of the metal-containing catalyst is disposed within pores of the substrate.

66. The device of claim 58, wherein the electron-permeable membrane comprises track-etched polycarbonate.

67. The device of claim 58, wherein the electron-permeable membrane comprises a porous substrate that has been selectively etched to expose metal-containing catalyst disposed within the pores of the substrate.

68. The device of claim 58, wherein the anode and the cathode of the fuel cell are fabricated from a material selected from the group consisting of gold, silver, platinum, and carbon.

69. The device of claim 58, wherein the anode and the cathode of the fuel cell are devoid of precious metals.

70. The device of claim 58, wherein one of the anode or the cathode of the fuel cell is devoid of precious metals.

71. A method to deplete carbon monoxide from a stream of gas, the method comprising: reacting an incoming gas comprising carbon monoxide with a solution comprising a transition metal in the presence of a metal-containing catalyst under conditions and for a time sufficient to reduce the transition metal and to oxidize the carbon monoxide to carbon dioxide, thereby depleting carbon monoxide from the stream of gas.

72. The method of claim 71, wherein the incoming gas is reacted with an aqueous solution comprising a transition metal compound selected from the group consisting of Cu(NO₃)₂, CuCl₂, CuCl, Bis(ethylene diamine)Cu(OH)₂, Co(NO₃)₂, CuSO₄, Fe(NO₃)₃, FeCl₃, KMnO₄, Ce(NO₃)₃, Ni(NO₃)₂, and Zn(NO₃)₂.

73. The method of claim 71, wherein the incoming gas is reacted with the transition metal solution in the presence of a metal-containing catalyst selected from the group consisting of transition metal-containing catalysts and inner transition metal-containing catalysts.

74. The method of claim 71, wherein the incoming gas is reacted with the transition metal solution in the presence of a metal-containing catalyst selected from the group consisting of Group VIIIB metal-containing catalysts and Group IB metal-containing catalysts.

75. The method of claim 71, wherein the incoming gas is reacted with the transition metal solution in the presence of a metal-containing catalyst selected from the group consisting of noble metal-containing catalysts

76. The method of claim 71, wherein the incoming gas is reacted with the transition metal solution in the presence of a gold-containing catalyst.

77. The method of claim 71, wherein the incoming gas is reacted with the transition metal solution in the presence of a metal-containing catalyst wherein the metal-containing catalyst is a nanotube, a nanoparticle, or a combination thereof.

78. The method of claim 71, wherein the incoming gas is reacted with the transition metal solution in the presence of a gold-containing catalyst wherein the gold-containing catalyst is a nanotube, a nanoparticle, or a combination thereof.

79. The method of claim 71, wherein the incoming gas is reacted with the transition metal solution in the presence of a metal-containing catalyst immobilized on a substrate.

80. The method of claim 79, wherein the metal-containing catalyst is immobilized on a porous substrate, and wherein a portion of the metal-containing catalyst is immobilized within pores of the substrate.

81. The method of claim 79, wherein the metal-containing catalyst is immobilized on a track-etched polycarbonate substrate.

82. The method of claim 79, further comprising selectively etching the porous substrate to expose metal-containing catalyst disposed within the pores of the substrate.
